(19) United States
(12) Patent Application Publication
(10) Pub. No.: US 2022/0011575 A1
(43) Pub. Date: Jan. 13, 2022

(54) LAMINATED GLASS AND HEAD-UP DISPLAY

(71) Applicant: FUJIFILM Corporation, Tokyo (JP)

(72) Inventor: Yujiro YANAI, Minamiashigara-shi (JP)

(73) Assignee: FUJIFILM Corporation, Tokyo (JP)

(21) Appl. No.: 17/487,076

(22) Filed: Sep. 28, 2021

Related U.S. Application Data
(63) Continuation of application No. PCT/JP2020/013506, filed on Mar. 26, 2020.

(30) Foreign Application Priority Data
Mar. 29, 2019 (JP) 2019-068334

(51) Int. Cl. G02B 27/01; G02B 5/30; B60K 35/00

(52) U.S. Cl. CPC G02B 27/0101; G02B 5/3016; B60K 2370/1529; G02B 5/3025; B60K 35/00; G02B 5/3083

(57) ABSTRACT

Provided are a laminated glass capable of achieving distant projection of a virtual image in a HUD and a large screen and furthermore capable of solving a double image, and a HUD using this laminated glass. The laminated glass includes two glass plates, an intermediate film provided between the two glass plates, and a cholesteric liquid crystal layer. The cholesteric liquid crystal layer has a liquid crystal alignment pattern in which a direction of a molecular axis of the liquid crystal compound changes while continuously rotating along at least one in-plane direction on at least one main surface, and a bright portion and a dark portion derived from a cholesteric liquid crystalline phase in a cross-section, which are observed by a scanning electron microscope, are tilted with respect to the main surfaces.

### CROSS-REFERENCE TO RELATED APPLICATIONS

This application is a Continuation of PCT International Application No. PCT/JP2020/013506 filed on Mar. 26, 2020, which claims priority under 35 U.S.C. § 119(a) to Japanese Patent Application No. 2019-068334 filed on Mar. 29, 2019. The above application is hereby expressly incorporated by reference, in its entirety, into the present application.

### BACKGROUND OF THE INVENTION

### 1. Field of the Invention

The present invention relates to a laminated glass used for a windshield of vehicles or the like and a head-up display.

### 2. Description of the Related Art

A so-called head-up display (head-up display system) that projects an image on a windshield of a vehicle or the like to provide information to a driver is known. In the following description, the head-up display is also referred to as “HUD”. In addition, “HUD” is an abbreviation for a “head up display”.

The driver can obtain various pieces of information such as a map, running speed, and vehicle condition by the HUD while looking at the outside ahead of the driver without moving eyes significantly. Therefore, it can be expected to drive more safely while the driver obtains various pieces of information.

As the windshield for vehicles, a so-called laminated glass in which an intermediate film made of polyvinyl butyral or the like is provided between the two glass plates is used.

In the HUD that projects an image on the windshield, for example, as described in JP2018-45210A, a half mirror for displaying a projection image is provided between glass plates and reflects a projection image from a projector to project an image, and the driver visibly recognizes the image projected.

At present, the HUD is desired to have a large screen and a distant projection that makes a virtual image be formed at a position far away. However, with the HUD using such a windshield in the related art, it is difficult to increase the screen size and perform the distant projection of the virtual image.

In addition, the HUD in the related art has a problem that a double image is observed.

### SUMMARY OF THE INVENTION

As described in JP2018-45210A, with the HUD in the related art, a projector that projects an image is placed in a dashboard, and the image is projected onto the windshield from below and reflected to project the image.

Here, the projection image from the projector is reflected not only by the half mirror between the laminated glasses but also by an outer glass of the vehicle. Reflection directions of an image reflected by the half mirror (main image) and an image reflected by the outer glass (sub image) are almost the same. Therefore, both the main image and the sub image are observed by the driver, resulting in a double image. Since the two images are separated from each other as an optical distance becomes longer, the double image deteriorates as the image formation position of the virtual image becomes farther.

Regarding the HUD, the driver is observing a virtual image of the image projected on the windshield. The image formation position of the virtual image is positioned ahead of the windshield and on the outer side of the vehicle.

On the other hand, the driver is driving while looking ahead for about 20 to 30 m. Therefore, considering the burden of switching the focus in order to observe an image of the HUD, it is preferable that the image formation position of the virtual image is far.

In a HUD projector, a real image (intermediate image) is displayed on a transmissive or reflective screen, and this real image is projected on the windshield. In order to make the image formation position of the virtual image far, it is necessary to increase an optical distance from the real image to the windshield. However, in the HUD, since the projector is disposed in the dashboard, there are many spatial restrictions, and the optical distance from the real image to the windshield cannot be increased. Therefore, with the HUD in the related art, it is difficult to project the virtual image from a distance, and the image formation position of the virtual image is limited to about several meters ahead of the vehicle and the outer side of the vehicle.

Furthermore, in order to increase the screen size, it is also necessary to increase the size of the projector. However, similarly, since there is a spatial restriction in the dashboard, the projector is limited to increase the size thereof.

In addition, the projection light from the projector is transmitted through the window provided on the dashboard and enters the windshield. In order to increase the screen size, it is necessary to increase the size of this window, but an increase in the size of the window formed on the dashboard is also restricted.

An object of the present invention is to solve such problems in the related art and provide a laminated glass capable of achieving distant projection of a virtual image in the HUD and a large screen and furthermore capable of solving a double image, and a HUD using this laminated glass.

The present invention achieves this object by the following configurations.

[1] A laminate glass comprising: two glass plates; an intermediate film provided between the two glass plates; and a cholesteric liquid crystal layer formed by using a liquid crystal compound, in which the cholesteric liquid crystal layer includes a pair of main surfaces and has a liquid crystal alignment pattern in which a direction of a molecular axis of the liquid crystal compound changes while continuously rotating along at least one in-plane direction on at least one main surface of the pair of main surfaces, and a bright portion and a dark portion derived from a cholesteric liquid crystalline phase in a cross-section perpendicular to the main surfaces of the cholesteric liquid crystal layer, which are observed by a scanning electron microscope, are tilted with respect to the main surfaces of the cholesteric liquid crystal layer.

[2] The laminated glass according to [1], further comprising a λ/4 plate.

[3] The laminated glass according to [1] or [2], in which the cholesteric liquid crystal layer includes a region where incidence angles of the bright portion and dark portion derived from the cholesteric liquid crystalline phase are different from each other.

[4] The laminated glass according to any one of [1] to [3], in which the cholesteric liquid crystal layer includes a region where tilt directions of the bright portion and dark portion derived from the cholesteric liquid crystalline phase are opposite to each other.

[5] The laminated glass according to any one of [1] to [4], in which the cholesteric liquid crystal layer is disposed between the two glass plates.

[6] The laminated glass according to any one of [1] to [4], in which the cholesteric liquid crystal layer is disposed on one of the two glass plates on a side opposite to the intermediate film.

[7] A head-up display comprising: the laminated glass according to any one of [1] to [6]; and a projector that emits projection light to the laminated glass, in which the projector is disposed on a ceiling of an image observation space.

[8] The head-up display according to [7], in which the projector emits P-polarized light to the laminated glass.

[9] The head-up display according to [7] or [8], in which the head-up display is mounted on a vehicle, and the projector is disposed on a ceiling in the vehicle.

According to the present invention, in the HUD, it is possible to project the virtual image from a distance and increase the screen size, and furthermore, it is possible to solve the double image.

### BRIEF DESCRIPTION OF THE DRAWINGS

FIG. 1 is a conceptual diagram of an example of a head-up display (HUD) according to an embodiment of the present invention.

FIG. 2 is a schematic diagram of an X-Y plane of a cholesteric liquid crystal layer used in the present invention.

FIG. 3 is a schematic diagram of an X-Z plane of an example of the cholesteric liquid crystal layer used in the present invention.

FIG. 4 is a schematic diagram of the X-Z plane of the cholesteric liquid crystal layer used in the present invention in a case of being observed with a scanning electron microscope.

FIG. 5 is a schematic diagram of an X-Z plane of a cholesteric liquid crystal layer in the related art.

FIG. 6 is a schematic diagram of the X-Z plane of the cholesteric liquid crystal layer in the related art in a case of being observed with a SEM.

FIG. 7 is a schematic diagram of an X-Y plane of another example of the cholesteric liquid crystal layer used in the present invention.

FIG. 8 is a schematic diagram of an X-Z plane of another example of the cholesteric liquid crystal layer used in the present invention.

FIG. 9 is a schematic cross-sectional diagram for explaining an example of an embodiment of a composition layer satisfying a condition 1 at a step 2-1.

FIG. 10 is a schematic cross-sectional diagram of a laminate including the cholesteric liquid crystal layer used in the present invention.

FIG. 11 is a schematic diagram of a graph plotting a relationship between helical twisting power (HTP) (μm⁻¹)×concentration (% by mass) and a light irradiation amount (mJ/cm²) with respect to a chiral agent A and a chiral agent B.

FIG. 12 is a schematic diagram of a graph plotting a relationship between a weighted average helical twisting power (μm⁻¹) and a light irradiation amount (mJ/cm²) in a system in which the chiral agent A and the chiral agent B are used in combination.

FIG. 13 is a schematic diagram of a graph plotting a relationship between a HTP (μm⁻¹)×a concentration (% by mass) and a temperature (° C.) with respect to each of the chiral agent A and the chiral agent B.

FIG. 14 is a schematic diagram of a graph plotting a relationship between a weighted average helical twisting power (μm⁻¹) and a temperature (° C.) in a system in which the chiral agent A and the chiral agent B are used in combination.

FIG. 15 is a schematic configuration view of an exposure device that irradiates an alignment film with interference light.

FIG. 16 is a conceptual diagram for explaining an operation of an example of the head-up display according to the embodiment of the present invention using a laminated glass according to the embodiment of the present invention.

FIG. 17 is a conceptual diagram for explaining an operation of an example of the head-up display according to the embodiment of the present invention using the laminated glass according to the embodiment of the present invention.

FIG. 18 is a conceptual diagram showing a laminated glass produced in Examples.

FIG. 19 is a conceptual diagram for explaining the laminated glass of FIG. 18.

FIG. 20 is a conceptual diagram for explaining a method of evaluating a double image in Examples.

FIG. 21 is a conceptual diagram for explaining a method of evaluating a double image in Examples.

### DESCRIPTION OF THE PREFERRED EMBODIMENTS

Hereinafter, a laminated glass and a head-up display (HUD) according to embodiments of the present invention will be described in detail based on suitable examples shown in the accompanying drawings.

In the present invention, the numerical range represented by “to” means a range including the numerical values before and after “to” as the lower limit value and the upper limit value.

Unless otherwise specified, an angle, a thickness, or the like may include a generally acceptable error range.

In the present invention, “(meth)acrylate” is used in the sense of “either one of or both of acrylate and methacrylate”.

In the present invention, the visible light is light at a wavelength that is visible to the human eyes among electromagnetic waves, and light in a wavelength range of 380 to 780 nm. Invisible light is light in a wavelength range of less than 380 nm or in a wavelength range of more than 780 nm.

Although light is not limited thereto, among the visible light, light in a wavelength range of 420 to 490 nm is blue (B) light, light in a wavelength range of 495 to 570 nm is green (G) light, and light in a wavelength range of 620 to 750 nm is red (R) light.

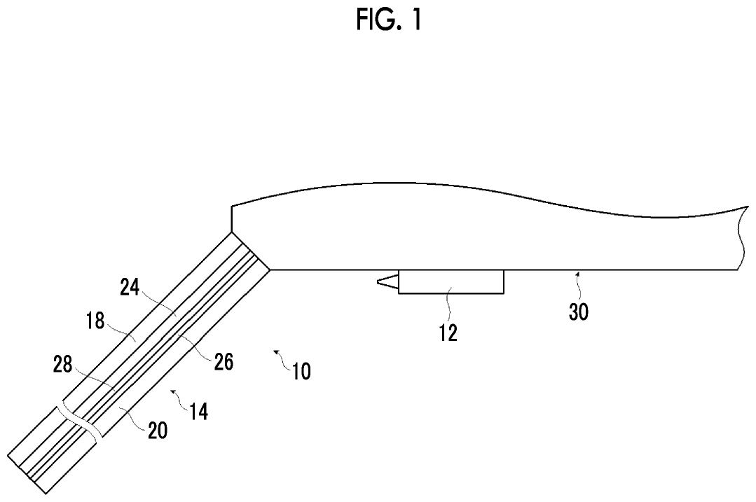

FIG. 1 is a conceptual diagram of an example of a head-up display (HUD) according to an embodiment of the present invention.

A HUD 10 shown in FIG. 1 is a HUD used for a vehicle such as a passenger car and includes a projector 12 and a windshield 14.

In the HUD 10, the windshield 14 is a laminated glass according to an embodiment of the present invention. Specifically, the laminated glass according to the embodiment of the present invention is a laminated glass for displaying a projection image.

The use of the laminated glass and the HUD according to the embodiment of the present invention is not limited, and can be used not only for vehicles but also for various transportation means having a windshield (windshield or windshield glass), such as aircraft, trains, and ships.

Therefore, in the following description, the inside and outside of the vehicle include, for example, the inside and outside of the aircraft, and the inside and outside of the ship.

[Projector]

In the HUD 10 according to the embodiment of the present invention, various known projectors (projection device (projector), image projection device (image projector)) used for the HUD can be used as the projector 12. Examples of the projector 12 include a liquid crystal on silicon (LCOS) projector, a laser projector, a liquid crystal projector (liquid crystal display), a digital mirror device (DMD) projector, a micro electro mechanical systems (MEMS) projector, and the like.

The projector 12 may be a fixed focus projector in which an image formation position of a virtual image cannot be changed, a variable focus projector in which an image formation position of a virtual image can be changed, or a multifocal projector in which a plurality of image formation positions of a virtual image are provided.

The HUD according to the embodiment of the present invention using the laminated glass according to the embodiment of the present invention can prevent the driver from observing a double image. Therefore, in the HUD according to the embodiment of the present invention, a variable focus projector and a multifocal projector whereby a double image can be easily observed can also be suitably used.

In the HUD 10 according to the embodiment of the present invention, as the projector 12, a projector in which projection light is linearly polarized light such as a LCOS projector, a laser projector, and a liquid crystal projector is suitably used. Alternatively, a projector that projects unpolarized projection light may be combined with a polarizer to project linearly polarized projection light.

In the HUD 10 according to the embodiment of the present invention, it is preferable that the projector 12 emits the projection light of P-polarized light (P wave) to (causes the projection light to be incident on) the windshield 14 (inner surface glass 20). The projector 12 more preferably projects the projection light of P-polarized light to the windshield 14 at Brewster's angle. As a result, the reflection of the projection light on the inner surface glass 20 is eliminated, and a clearer image can be displayed.

In the HUD 10 according to the embodiment of the present invention, the projector 12 is provided on a ceiling 30 inside a vehicle. This point will be described in detail later.

[Windshield]

The windshield 14 is a laminated glass according to the embodiment of the present invention.

The windshield 14 of an illustrated example includes an outer surface glass 18, the inner surface glass 20, an intermediate film 24, a λ/4 plate 26, and a cholesteric liquid crystal layer 28.

In FIG. 1, the λ/4 plate 26 and the cholesteric liquid crystal layer 28 are provided on the entire surface of the windshield 14, but the present invention is not limited thereto. That is, in the windshield 14, the λ/4 plate 26 and the cholesteric liquid crystal layer 28 may be provided only in a region corresponding to the display of an image by the HUD 10.

<Outer Surface Glass and Inner Surface Glass>

The outer surface glass 18 and the inner surface glass 20 are both known glass (glass plates) used for windshields of vehicles and the like. Therefore, forming materials, thicknesses, shapes, and the like may be the same as those of glass used for known windshields.

In the illustrated example, the outer surface glass 18 and the inner surface glass 20 are both flat plates, but each of the outer surface glass 18 and the inner surface glass 20 may have a curved surface in part or the entire surface may be curved.

<Intermediate Film>

The intermediate film 24 is a known intermediate film (an intermediate layer and an adhesive layer) used for the windshield of the laminated glass, which prevents pieces of glass from penetrating into a vehicle and scattering when an accident happens and which is formed by bonding the outer surface glass 18 to a laminate in which the cholesteric liquid crystal layer 28, the λ/4 plate 26, and the inner surface glass 20 are laminated.

The intermediate film 24 is not limited, and a known intermediate film used for the windshield can be used. Examples of the forming materials for the intermediate film 24 include polyvinyl butyral (PVB), ethylene-vinyl acetate copolymer, chlorine-containing resin, polyurethane, and the like.

A thickness of the intermediate film 24 is not limited, and the thickness depending on the forming materials or the like may be set to a thickness of the known intermediate film of the windshield in the same manner.

In the windshield 14 of the illustrated example, the intermediate film 24 is provided between the outer surface glass 18 and the cholesteric liquid crystal layer 28, but the present invention is not limited thereto.

For example, the intermediate film 24 may be provided between the inner surface glass 20 and the λ/4 plate 26.

In the windshield 14 of the illustrated example, an intermediate film or an adhesive layer (pressure sensitive adhesive layer) for the purpose of bonding the cholesteric liquid crystal layer 28 and the λ/4 plate 26 to the inner surface glass 20 may be provided between the λ/4 plate 26 and the inner surface glass 20 as necessary.

In the windshield 14 of the illustrated example, the λ/4 plate 26 and the cholesteric liquid crystal layer 28 are provided between the outer surface glass 18 and the inner surface glass 20, but the present invention is not limited thereto.

That is, the λ/4 plate 26 and the cholesteric liquid crystal layer 28 may be provided on the inner surface glass 20 at the inside of the vehicle, for example. According to this configuration, the laminated glass according to the embodiment of the present invention can be realized without changing the configuration of the general laminated glass.

In any case, the λ/4 plate 24 is disposed closer to the projector 12 than the cholesteric liquid crystal layer 28.

<λ/4 Plate>

The λ/4 plate 26 is a plate having an in-plane retardation value of Re (λ)=λ/4 (or odd number times thereof) at a predetermined wavelength λ nm. This expression may be achieved at any wavelength in the visible light region (for example, 550 nm).

The λ/4 plate may have a configuration consisting of only an optically anisotropic layer having a λ/4 function, or may have a configuration in which an optically anisotropic layer having a λ/4 function is formed on a support. In a case where the λ/4 plate includes a support, it is intended that a combination of the support and the optically anisotropic layer is the λ/4 plate.

As the λ/4 plate 26, a known λ/4 plate can be used.

Here, the λ/4 plate 26 is preferably made of a material having a reverse birefringence dispersion. As a result, the λ/4 plate 26 can correspond to light having a wide-band wavelength.

The λ/4 plate 26 converts linearly polarized projection light emitted by the projector 12 into circularly polarized light.

In a case where the projector 12 emits unpolarized projection light, the λ/4 plate 26 converts a linearly polarized light component in the projection light emitted by the projector 12 into circularly polarized light.

<Cholesteric Liquid Crystal Layer>

The cholesteric liquid crystal layer 28 is a layer formed by a liquid crystal compound being aligned in a cholesteric state. In other words, the cholesteric liquid crystal layer 28 is a layer formed by a cholesteric liquid crystalline phase being immobilized.

In the present invention, regarding the cholesteric liquid crystal layer, it is sufficient that optical properties of the cholesteric liquid crystalline phase are retained in the layer, and the liquid crystal compound in the layer may not exhibit liquid crystallinity.

The cholesteric liquid crystal layer 28 has wavelength-selective reflectivity and circular polarization-selective reflectivity. That is, the cholesteric liquid crystal layer 28 reflects dextrorotatory circularly polarized light or levorotatory circularly polarized light of a selective reflection wavelength, and transmits light in another wavelength region and light in another revolving direction.

The cholesteric liquid crystal layer 28 reflects this circularly polarized light in a case where a revolving direction of the circularly polarized light transmitted through the λ/4 plate 26 is the same as a revolving direction of the circularly polarized light reflected by the cholesteric liquid crystal layer 28. The cholesteric liquid crystal layer 28 transmits this circularly polarized light in a case where the revolving direction of the circularly polarized light transmitted through the λ/4 plate 26 is opposite to the revolving direction of the circularly polarized light reflected by the cholesteric liquid crystal layer 28.

The cholesteric liquid crystal layer included in the windshield 14 (the laminated glass according to the embodiment of the present invention) may be formed with one layer or a plurality of layers having different selective reflection wavelengths.

As an example, the windshield 14 may include only one cholesteric liquid crystal layer that selectively reflects green light and transmits other light. In this case, the HUD 10 displays a green monochrome image. Alternatively, the windshield 14 may include only one cholesteric liquid crystal layer that selectively reflects red light and transmits other light. In this case, the HUD 10 displays a red monochrome image.

The windshield 14 may include two cholesteric liquid crystal layers constituted of the cholesteric liquid crystal layer that selectively reflects green light and transmits other light, and the cholesteric liquid crystal layer that selectively reflects red light and transmits other light. In this case, the HUD 10 displays a two-color image of green and red.

Furthermore, the windshield 14 may include three cholesteric liquid crystal layers constituted of the cholesteric liquid crystal layer that selectively reflects green light and transmits other light, the cholesteric liquid crystal layer that selectively reflects red light and transmits other light, and a cholesteric liquid crystal layer that selectively reflects blue light and transmits other light. In this case, the HUD 10 displays a blue, green and red full-color image.

The windshield 14 is a laminated glass according to the embodiment of the present invention.

Therefore, the cholesteric liquid crystal layer 28 has a liquid crystal alignment pattern in which a direction of a molecular axis of the liquid crystal compound changes while continuously rotating along at least one in-plane direction on at least one main surface of a pair of main surfaces. In addition, a bright portion and a dark portion derived from a cholesteric liquid crystalline phase in a cross-section perpendicular to the main surfaces of the cholesteric liquid crystal layer 28, which are observed by a scanning electron microscope (SEM), are tilted with respect to the main surfaces of the cholesteric liquid crystal layer 28.

As described in detail later, the cholesteric liquid crystal layer reflects light with a surface parallel to the bright portion and the dark portion (hereinafter, also referred to as bright and dark lines) observed in the SEM cross-section as a reflecting surface. The reflection on this reflecting surface is specular reflection. Therefore, the cholesteric liquid crystal layer 28 having the bright and dark lines tilted with respect to the main surfaces reflects the incident light at an angle different from an incident angle with respect to the main surfaces. In the following description, the fact that the cholesteric liquid crystal layer 28 has a property of reflecting incident light at an angle different from an incident angle with respect to main surfaces is also referred to as the cholesteric liquid crystal layer 28 having reflection anisotropy.

<<Liquid Crystal Alignment Pattern>>

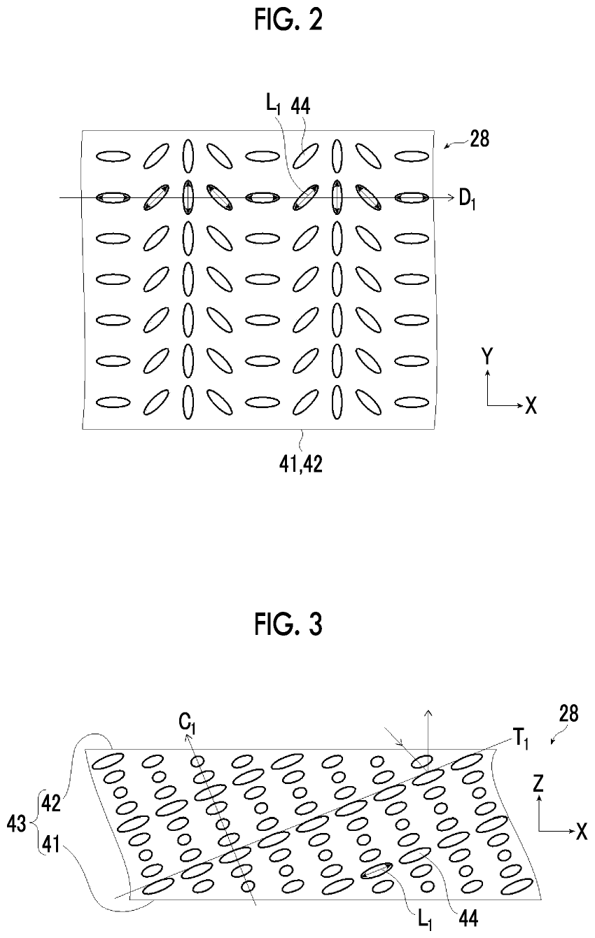

FIGS. 2 and 3 are schematic diagrams conceptually showing alignment states of the liquid crystal compound in the cholesteric liquid crystal layer.

FIG. 2 is a schematic diagram showing an alignment state of the liquid crystal compound in planes of a main surface 41 and a main surface 42 of the cholesteric liquid crystal layer 28 having a pair of main surfaces 43 consisting of the main surface 41 and the main surface 42. FIG. 3 is a schematic cross-sectional diagram showing a cholesteric liquid crystalline phase state in the cross-section perpendicular to the main surface 41 and the main surface 42.

In the following, the main surface 41 and the main surface 42 of the cholesteric liquid crystal layer 28 are referred to as an X-Y plane, and the cross-section perpendicular to this X-Y plane is referred to as an X-Z plane. That is, FIG. 2 corresponds to a schematic diagram of the X-Y plane of the cholesteric liquid crystal layer 28, and FIG. 3 corresponds to a schematic diagram of the X-Z plane of the cholesteric liquid crystal layer 28.

In the following, a case where a rod-like liquid crystal compound is used as the liquid crystal compound will be described as an example.

As shown in FIG. 2, in the X-Y plane of the cholesteric liquid crystal layer 28, liquid crystal compounds 44 are arranged along a plurality of arrangement axes D₁ parallel to each other in the X-Y plane, and at each arrangement axis D₁, the liquid crystal compounds 44 form a liquid crystal alignment pattern in which a direction of a molecular axis L₁ of each liquid crystal compound 44 changes while continuously rotating in one direction along the arrangement axis D₁ in the plane. Here, as an example, it is assumed that the arrangement axis D₁ is oriented in the X direction. In addition, in the Y direction, the liquid crystal compounds 44 having the same direction of the molecular axis L₁ are aligned at equal intervals.

In addition, the “direction of a molecular axis L₁ of the liquid crystal compound 44 changes while continuously rotating in one direction along the arrangement axis D₁ in the plane” means that an angle between the molecular axis L₁ and the arrangement axis D₁ of the liquid crystal compound 44 differs depending on a position in a direction of the arrangement axis D₁, and the angle between the molecular axis L₁ and the arrangement axis D₁, which is formed along the arrangement axis D₁, gradually changes from θ1 to θ1+180° or θ₁-180°. That is, as shown in FIG. 2, in the plurality of liquid crystal compounds 44 arranged along the arrangement axis D₁, the molecular axis L₁ changes while rotating along the arrangement axis D₁ by a constant angle.

In the present specification, in a case where each liquid crystal compound 44 is a rod-like liquid crystal compound, the molecular axis L₁ of each liquid crystal compound 44 is intended to be a molecular major axis of the rod-like liquid crystal compound. On the other hand, in a case where each liquid crystal compound 44 is a disk-like liquid crystal compound, the molecular axis L₁ of each liquid crystal compound 44 is intended to be an axis parallel to the normal direction of the disk-like liquid crystal compound with respect to a disc plane. Furthermore, the molecular axis coincides with an optical axis derived from the liquid crystal compound.

FIG. 3 is a schematic diagram of an X-Z plane of the cholesteric liquid crystal layer 28.

In the X-Z plane of the cholesteric liquid crystal layer 28 shown in FIG. 3, the molecular axis L₁ of each liquid crystal compound 44 is aligned to be tilted with respect to the main surface 41 and the main surface 42 (the X-Y plane).

An average angle (average tilt angle) θ₃ between the molecular axis L₁ of each liquid crystal compound 44 and the main surface 41 and main surface 42 (the X-Y plane) is preferably 5° to 45°, and more preferably 10° to 40°. The angle θ₃ can be measured by the observation of the X-Z plane of the cholesteric liquid crystal layer 28 with a polarization microscope. Among them, in the X-Z plane of the cholesteric liquid crystal layer 28, the liquid crystal compounds 44 are preferably aligned such that the molecular axis L₁ of each liquid crystal compound 44 is tilted in the same direction with respect to the main surface 41 and main surface 42 (the X-Y plane).

In the observation of the cross-section of the cholesteric liquid crystal layer with a polarization microscope, the average angle is a value obtained by measuring an angle between the molecular axis L₁ of each liquid crystal compound 44 and the main surface 41 and main surface 42 at any five or more points and arithmetically averaging the measured angles.

As shown in FIG. 3, since the molecular axis L₁ is aligned as described above, in the cholesteric liquid crystal layer 28, a helical axis C₁ derived from the cholesteric liquid crystalline phase is tilted at a predetermined angle with respect to the main surface 41 and main surface 42 (the X-Y plane). That is, a reflecting surface T₁ of the cholesteric liquid crystal layer 28 is tilted in a substantially constant direction with respect to the main surface 41 and main surface 42 (the X-Y plane). The reflecting surface T₁ of the cholesteric liquid crystal layer 28 is a plane on which the liquid crystal compounds that are orthogonal to the helical axis C₁ and have the same azimuthal angle as each other exist.

“liquid crystal molecules having the same azimuthal angle as each other” means liquid crystal molecules having the same alignment direction of the molecular axes when the projection is performed onto the main surface 41 and main surface 42 (the X-Y plane).

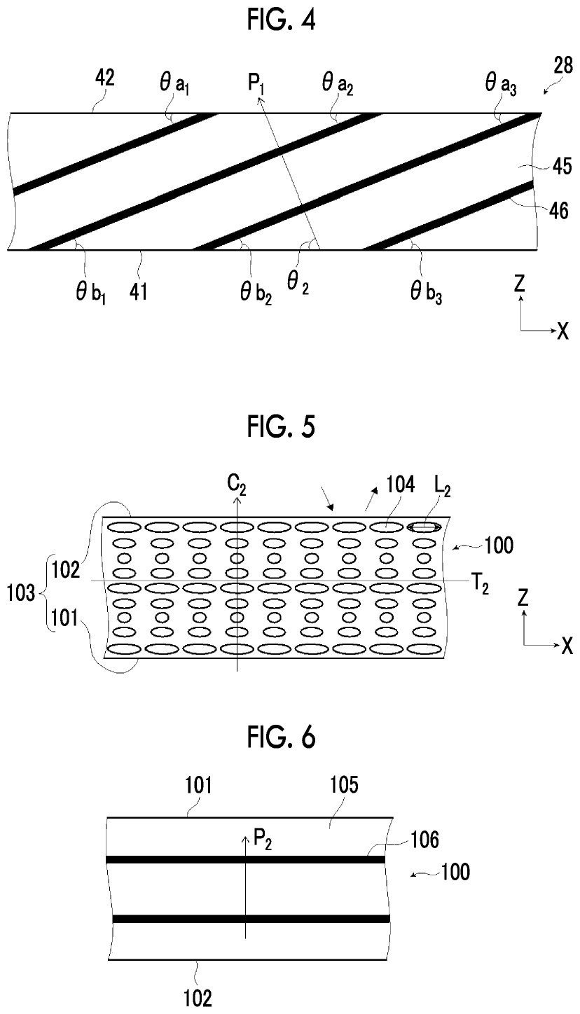

In a case where the X-Z plane of the cholesteric liquid crystal layer 28 shown in FIG. 3 is observed with the SEM, a stripe pattern in which an arrangement direction P₁ where a bright portion 45 and a dark portion 46 are alternately arranged as shown in FIG. 4 is tilted at a predetermined angle θ₂ with respect to the main surface 41 and main surface 42 (the X-Y plane) is observed.

Two bright portions 45 and two dark portions 46 in FIG. 4 correspond to one helical pitch (one helical winding) in the cholesteric liquid crystalline phase. One helical pitch in the cholesteric liquid crystalline phase, that is, a length of the helical pitch is a length of a pitch P (=helical period) of a helical structure of the cholesteric liquid crystalline phase. As an example, the length of the helical pitch of the cholesteric liquid crystalline phase can be measured by a method described on page 196 of Liquid Crystal Handbook (Maruzen Publishing Co., Ltd.).

In the cholesteric liquid crystal layer 28, the molecular axis L₁ of each liquid crystal compound 44 is substantially orthogonal to the arrangement direction P₁ in which the bright portion 45 and the dark portion 46 are alternately arranged.

The angle formed between the molecular axis L₁ and the arrangement direction P₁ is preferably 80° to 90°, and more preferably 85° to 90°.

<<Reflection Anisotropy>>

Hereinafter, the reason why reflection anisotropy of the cholesteric liquid crystal layer 28 can be obtained will be described.

FIG. 5 is a schematic cross-sectional diagram of a cholesteric liquid crystal layer in the related art. Specifically, FIG. 5 shows a state of a cholesteric liquid crystal layer in a cross-section perpendicular to a main surface 103 of a cholesteric liquid crystal layer 100 having a pair of main surfaces 103 consisting of a main surface 101 and a main surface 102. In the following, the main surface 101 and the main surface 102 of the cholesteric liquid crystal layer 100 are referred to as an X-Y plane, and the cross-section perpendicular to this X-Y plane is referred to as an X-Z plane. That is, FIG. 5 corresponds to a schematic diagram of the cholesteric liquid crystal layer 100 on the X-Z plane.

In the cholesteric liquid crystal layer 100 shown in FIG. 5, a helical axis C₂ derived from a cholesteric liquid crystalline phase is perpendicular to the main surface 101 and main surface 102 (the X-Y plane), and a reflecting surface T₂ thereof is a plane parallel to the main surface 101 and main surface 102 (the X-Y plane). A molecular axis L₂ of a liquid crystal compound 104 is not tilted with respect to the main surface 101 and main surface 102 (the X-Y plane). In other words, the molecular axis L₂ is parallel to the main surface 101 and main surface 102 (the X-Y plane). Therefore, as shown in FIG. 6, in a case where the X-Z plane of the cholesteric liquid crystal layer 100 is observed with the SEM, an arrangement direction P₂ in which a bright portion 25 and a dark portion 26 are alternately arranged is perpendicular to the main surface 101 and main surface 102 (the X-Y plane).

Since the cholesteric liquid crystalline phase has a specular reflection property, for example, in a case where light is incident on the cholesteric liquid crystal layer 100 from an oblique direction, the light is reflected in the oblique direction at a reflection angle of the same angle as an incident angle (see the arrow in FIG. 5).

On the other hand, the cholesteric liquid crystal layer 28 shown in FIGS. 2 and 3 has reflection anisotropy since the reflecting surface T₁ is tilted in a predetermined direction with respect to the main surface 41 and main surface 42 (the X-Y plane). For example, in a case where light is incident on the cholesteric liquid crystal layer 28 from the oblique direction, the light is reflected by the reflecting surface T₁ in the normal direction of the main surface 41 and main surface 42 (the X-Y plane) (see the arrow in FIG. 3). The normal line is a line orthogonal to a main surface of a layer (a sheet-like object, a plate-like object, or a film). Therefore, the normal direction is a direction orthogonal to the main surface of the layer.

<<Cholesteric Liquid Crystalline Phase>>

A cholesteric liquid crystalline phase is known to exhibit selective reflectivity at a specific wavelength. A center wavelength λ of selective reflection (selective reflection center wavelength) depends on a pitch P (=helix period) of a helical structure in the cholesteric liquid crystalline phase, and is based on a relationship between an average refractive index n of the cholesteric liquid crystalline phase and A, =n×P. Therefore, the selective reflection center wavelength can be adjusted by adjusting the pitch of this helical structure. During the formation of an optically anisotropic layer, the pitch of the cholesteric liquid crystalline phase depends on a type of a chiral agent used together with the liquid crystal compound or on an added concentration thereof, so that a desired pitch can be obtained by adjusting the type or the concentration.

Regarding the pitch adjustment, there is a detailed description in Fuji Film Research & Development Report No. 50 (2005) p. 60-63. As a method of measuring a helical sense or a pitch, methods described in “Introduction to Experimental Liquid Crystal Chemistry”, edited by The Japanese Liquid Crystal Society, published in 2007 by Sigma Publishing Co., Ltd., p. 46, and “Liquid Crystal Handbook”, the Editing Committee of Liquid Crystal Handbook, Maruzen Publishing Co., Ltd., p. 196 can be used.

The cholesteric liquid crystalline phase exhibits selective reflectivity in response to either levorotatory circularly polarized light or dextrorotatory circularly polarized light at a specific wavelength. Whether or not the reflected light is dextrorotatory circularly polarized light or levorotatory circularly polarized light is determined depending on a helically twisted direction (sense) of the cholesteric liquid crystalline phase. Regarding the selective reflection of the circularly polarized light by the cholesteric liquid crystalline phase, in a case where the helically twisted direction of the cholesteric liquid crystalline phase is dextrorotatory, the dextrorotatory circularly polarized light is reflected, and in a case where the helically twisted direction of the cholesteric liquid crystalline phase is levorotatory, the levorotatory circularly polarized light is reflected.

A revolving direction of the cholesteric liquid crystalline phase can be adjusted by types of liquid crystal compounds for forming an optically-anisotropic layer and/or types of added chiral agents.

In addition, a half-width Δλ (nm) of a selective reflection band (circular polarization reflection band) exhibiting selective reflection depends on Δn of the cholesteric liquid crystalline phase and the helical pitch P, and is based on a relationship of Δλ=Δn×P. Accordingly, a width of the selective reflection band can be controlled by the Δn being adjusted. The Δn can be adjusted according to types of liquid crystal compounds for forming the cholesteric liquid crystal layer and a mixing ratio thereof, and a temperature during immobilization of alignment.

The half-width in a reflection wavelength region is adjusted according to the use of the cholesteric liquid crystal layer, and may be, for example, 10 to 500 nm, preferably 20 to 300 nm, and more preferably 30 to 100 nm.

On the other hand, in the cholesteric liquid crystal layer 28, as described above, the liquid crystal compounds 44 are aligned such that the molecular axis L₁ of each liquid crystal compound 44 is tilted with respect to the main surface 41 and main surface 42 (the X-Y plane), in the X-Z plane, and on the main surface 41 and main surface 42 (the X-Y plane), the direction of the molecular axis L₁ of each liquid crystal compound 44 changes while continuously rotating in one direction along the arrangement axis D₁ in the plane. It is presumed that the cholesteric liquid crystal layer 28 exhibits high linearity in the bright and dark lines consisting of the bright portion and dark portion derived from the cholesteric liquid crystalline phase observed with the SEM on the X-Z plane, with this configuration. As a result, low haze and high transparency are achieved.

That is, the higher the linearity of a line (bright line) formed by the bright portion 45 and a line (dark line) formed by the dark portion 46 (see FIG. 4), which are derived from the cholesteric liquid crystalline phase observed with the SEM on the X-Z plane, the lower the haze and the more excellent the transparency of the cholesteric liquid crystal layer 28 shown in FIGS. 2 to 4. Above all, in a case where an average incidence angle between the line formed by the dark portion 46 derived from the cholesteric liquid crystalline phase and the main surface 41 and an average incidence angle between the line formed by the dark portion 46 and the main surface 42 are the same as each other, the lower haze and the more excellent transparency are achieved.

Each average incidence angle is obtained as an average value of an angle formed by the line formed by the dark portion 46 and the main surface 41 or the main surface 42 in the bright and dark lines (see FIG. 4) derived from the cholesteric liquid crystalline phase observed with the SEM on the X-Z plane. That is, the average incidence angle on the main surface 42 side is obtained as an average value of incidence angles θₐ₁, θₐ₂, and . . . θₐₙ between the line formed by the dark portion 46 on the main surface 42 side and the main surface 42. The average incidence angle on the main surface 41 side is obtained as an average value of incidence angles θ_{b1}, θ_{b2}, and . . . θ_{bn} between the line formed by the dark portion 46 on the main surface 41 side and the main surface 41.

From the viewpoint that the cholesteric liquid crystal layer 28 has the lower haze and is more excellent in transparency, a difference between the average incidence angle on the main surface 41 side and the average incidence angle on the main surface 42 side is preferably 0° to 20°, more preferably 0° to 5°, and even more preferably 0° to 1°, for example. In an image observed with the SEM, the average incidence angle is a value obtained by measuring an angle between the line formed by the dark portion 46 derived from the cholesteric liquid crystalline phase and the main surface 41 (or main surface 42) at any five or more points and arithmetically averaging the measured angles.

In the cholesteric liquid crystal layer 28 shown in FIG. 3, the molecular axis of each liquid crystal compound 44 is tilted with respect to the main surface 43 of the cholesteric liquid crystal layer 28.

However, the present invention is not limited thereto, and the molecular axis of each liquid crystal compound may be parallel to the main surface of the cholesteric liquid crystal layer.

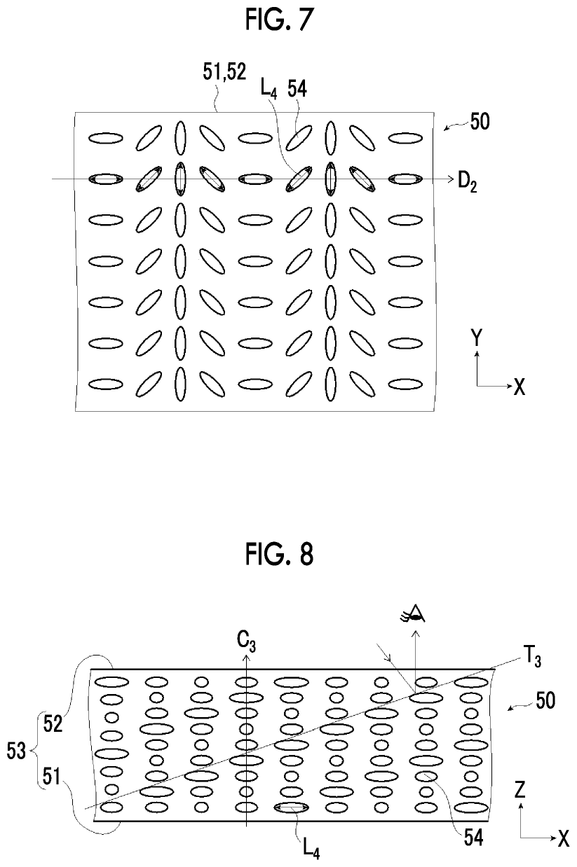

FIGS. 7 and 8 are schematic diagrams of another example of the cholesteric liquid crystal layer used in the present invention.

FIG. 7 is a schematic diagram conceptually showing an alignment state of the liquid crystal compounds in a main surface 51 and a main surface 52 of a cholesteric liquid crystal layer 40 having a pair of main surfaces 53 consisting of the main surface 51 and the main surface 52. FIG. 8 shows a state of a cholesteric liquid crystal layer in a cross-section perpendicular to the main surfaces 53 of the cholesteric liquid crystal layer 50.

In the following, the main surface 51 and main surface 52 of the cholesteric liquid crystal layer 50 are referred to as an X-Y plane, and the cross-section perpendicular to this X-Y plane is referred to as an X-Z plane. That is, FIG. 7 is a schematic diagram of the cholesteric liquid crystal layer 50 on the X-Y plane, and FIG. 8 is a schematic diagram of the cholesteric liquid crystal layer 50 on the X-Z plane.

As shown in FIG. 7, in the X-Y plane of the cholesteric liquid crystal layer 50, liquid crystal compounds 54 are arranged along a plurality of arrangement axes D₂ parallel to each other in the X-Y plane, and at each arrangement axis D₂, a direction of a molecular axis L₄ of each liquid crystal compound 54 changes while continuously rotating in one direction along the arrangement axis D₂ in the plane. That is, an alignment state of the liquid crystal compound 54 on the X-Y plane of the cholesteric liquid crystal layer 50 is the same as the alignment state of the liquid crystal compound 44 on the X-Y plane of the cholesteric liquid crystal layer 28 shown in FIG. 3.

As shown in FIG. 8, in the X-Z plane of the cholesteric liquid crystal layer 50, the molecular axis L₄ of the liquid crystal compound 54 is not tilted with respect to the main surface 51 and main surface 52 (the X-Y plane). In other words, the molecular axis L₄ is parallel to the main surface 51 and main surface 52 (the X-Y plane).

Since the cholesteric liquid crystal layer 50 has the X-Y plane shown in FIG. 7 and the X-Z plane shown in FIG. 8 described above, a helical axis C₃ derived from a cholesteric liquid crystalline phase is perpendicular to the main surface 51 and main surface 52 (the X-Y plane), and a reflecting surface T₃ thereof is tilted in a predetermined direction with respect to the main surface 51 and main surface 52 (the X-Y plane). In a case where the X-Z plane of the cholesteric liquid crystal layer 50 is observed with the SEM, a stripe pattern in which an arrangement direction where a bright portion and a dark portion are alternately arranged is tilted at a predetermined angle with respect to the main surface 51 and main surface 52 (the X-Y plane) is observed (in the same as FIG. 4).

As described above, in the cholesteric liquid crystal layer 28, the molecular axis of each liquid crystal compound may be parallel to the main surface of the cholesteric liquid crystal layer.

In the cholesteric liquid crystal layer 28 shown in FIGS. 2 and 3, the molecular axis L₁ is substantially orthogonal to the arrangement direction P₁ in which the bright portion 45 and the dark portion 46 observed by the SEM observation on the X-Z plane are alternately arranged. That is, a direction of the helical axis C₁ is substantially parallel to the arrangement direction P₁ in which the bright portion 45 and the dark portion 46 are alternately arranged. As a result, light incident from an oblique direction and the helical axis C₁ are more likely to be parallel, and reflected light on the reflecting surface has a high degree of circular polarization.

On the other hand, in a case of the cholesteric liquid crystal layer 50, since the helical axis C₃ is perpendicular to the main surface 51 and main surface 52 (the X-Y plane), an incident direction of light incident from an oblique direction and a direction of the helical axis C₃ form a larger angle. That is, the incident direction of the light incident from the oblique direction and the direction of the helical axis C₃ are more non-parallel. Therefore, the cholesteric liquid crystal layer 28 has a higher degree of circular polarization of the reflected light on the reflecting surface than the cholesteric liquid crystal layer 50.

Here, in both the main surface 41 and main surface 42 of the cholesteric liquid crystal layer 28 shown in FIGS. 2 and 3, the direction of the molecular axis L₁ of each liquid crystal compound 44 changes while continuously rotating in one direction along the arrangement axis D₁ in the plane, but in only one main surface, the direction of the molecular axis of the liquid crystal compound may change while continuously rotating in one direction along the arrangement axis in the plane.

In the cholesteric liquid crystal layer, the arrangement axis existing on one main surface is preferably parallel to the arrangement axis existing on the other main surface.

Here, in the present invention, regarding the main surface of the cholesteric liquid crystal layer, in which the direction of the molecular axis of each liquid crystal compound is changed while continuously rotating along at least one direction in the plane, a length of rotation of the direction of the molecular axis of each liquid crystal compound by 180° is a single period Λ.

In the cholesteric liquid crystal layer, the shorter the length of the single period Λ, the greater the incidence angle θ formed between the dark portion and the main surface. Therefore, in the cholesteric liquid crystal layer, the shorter the length of the single period Λ, the greater the difference between an incident angle of the incident light with respect to the main surface and a reflection angle with respect to the main surface. In other words, the shorter the single period Λ, the greater the reflection anisotropy.

The difference between the incident angle of the incident light with respect to the main surface and the reflection angle with respect to the main surface is greater as a wavelength of the incident light is longer.

Therefore, the single period Λ of the cholesteric liquid crystal layer may be appropriately set according to a wavelength of light projected by the projector 12 and a direction of the light reflected on the windshield 14 (cholesteric liquid crystal layer 28).

The single period Λ in the cholesteric liquid crystal layer corresponds to an interval between the bright and dark lines in the reflection polarization microscope observation. Therefore, a coefficient of variation (standard deviation/average value) of the single period Λ may be calculated by measuring the interval between the bright and dark lines in the reflection polarization microscope observation at 10 points on each of the main surfaces of the cholesteric liquid crystal layer.

<<Method of Forming Cholesteric Liquid Crystal Layer>>

Examples of a method of forming a cholesteric liquid crystal layer used for the laminated glass according to the embodiment of the present invention include a method using a predetermined liquid crystal layer as an alignment substrate of the cholesteric liquid crystal layer, and a liquid crystal composition including a chiral agent X whose helical twisting power (HTP) changes due to irradiation with light or a chiral agent Y having a helical twisting power changed depending on a temperature change.

The method of forming a cholesteric liquid crystal layer will be described in detail below.

One embodiment of the method of forming a cholesteric liquid crystal layer includes a step 1 and a step 2 described below.

Step 1: a step 1 of forming a liquid crystal layer in which a molecular axis of a disk-like liquid crystal compound on at least one surface is tilted with respect to the surface by using a composition including the disk-like liquid crystal compound.

Step 2: a step 2 of forming a cholesteric liquid crystal layer on the liquid crystal layer by using a composition including a liquid crystal compound.

Hereinafter, the steps 1 and 2 will be described in detail with the above described cholesteric liquid crystal layer 28 as an example.

[Step 1]

The step 1 is a step of forming a liquid crystal layer using a composition including a disk-like liquid crystal compound.

On at least one surface of the liquid crystal layer, the molecular axis of the disk-like liquid crystal compound is tilted with respect to the surface. In other words, on the at least one surface of the liquid crystal layer, the molecular axis of the disk-like liquid crystal compound is aligned to be tilted with respect to the surface. In this formation method, the liquid crystal layer includes a surface in which the disk-like liquid crystal compound is tilted and aligned (hereinafter, also referred to as a “tilt alignment surface”), and a cholesteric liquid crystal layer is formed on the tilt alignment surface of the liquid crystal layer.

The specific method of the step 1 is not particularly limited and preferably includes a step 1-1 and a step 1-2 described below. In the following, as a method of allowing a disk-like liquid crystal compound to be in a tilt alignment state, there is a method (step 1-1) of forming a composition layer using a substrate on which a rubbing alignment film having a pretilt angle is disposed on a surface thereof, but the method of allowing a disk-like liquid crystal compound to be in a tilt alignment state is not limited thereto, and for example, a method of adding a surfactant to a liquid crystal layer-forming composition (for example, a step 1-1′ described below) may be used. In this case, in the step 1, the following step 1-1′ may be performed instead of the step 1-1.

Step 1-1′: a step of forming a composition layer on a substrate (a rubbing alignment film may not be disposed on a surface thereof) by using a composition including a disk-like liquid crystal compound and a surfactant

In a case where the disk-like liquid crystal compound has a polymerizable group, the composition layer is preferably subjected to a curing treatment in the step 1 as described later.

Step 1-1: a step of forming a composition layer on a substrate on which a rubbing alignment film having a pretilt angle is disposed on a surface thereof by using a composition (liquid crystal layer-forming composition) including a disk-like liquid crystal compound

Step 1-2: a step of allowing the disk-like compound in the composition layer to be in an alignment state

The step 1 will be described below.

-Substrate-

A substrate is a plate that supports a composition layer described later. Among substrates, a transparent substrate is preferable. The transparent substrate is intended to be a substrate having a visible light transmittance of 60% or more, and the transmittance is preferably 80% or more, and more preferably 90% or more.

Materials constituting the substrate is not particularly limited, and examples thereof include a cellulose polymer, polycarbonate polymer, a polyester polymer, a (meth) acrylic polymer, a styrene polymer, a polyolefin polymer, a vinyl chloride polymer, an amide polymer, an imide polymer, a sulfone polymer, a polyether sulfone polymer, a polyether ether ketone polymer, and the like.

The substrate may contain various additives such as a UV (ultraviolet) absorber, matting fine particles, a plasticizer, a deterioration inhibitor, and a release agent.

The substrate preferably has low birefringence in the visible light region. For example, retardation of the substrate at a wavelength of 550 nm is preferably 50 nm or less, and more preferably 20 nm or less.

A thickness of the substrate is not particularly limited, but is preferably 10 to 200 and more preferably 20 to 100 μm from the viewpoint of thinning and handleability.

The above thickness is intended as an average thickness, and thicknesses at any five points on the substrate are measured and arithmetically averaged. Regarding the method of measuring this thickness, a thickness of the liquid crystal layer and a thickness of the cholesteric liquid crystal layer described later are also the same.

The type of the rubbing alignment film having a pretilt angle is not particularly limited, and for example, a polyvinyl alcohol alignment film, a polyimide alignment film, or the like can be used.

-Liquid Crystal Layer-Forming Composition-

Hereinafter, a liquid crystal layer-forming composition will be described.

(Disc-Like Liquid Crystal Compound)

The liquid crystal layer-forming composition contains a disk-like liquid crystal compound.

The disk-like liquid crystal compound is not particularly limited, and known compounds can be used, but among these, those having a triphenylene skeleton are preferable.

The disk-like liquid crystal compound may have a polymerizable group. The type of the polymerizable group is not particularly limited, a functional group capable of an addition polymerization reaction is preferable, and a polymerizable ethylenically unsaturated group or a ring-polymerizable group is more preferable. More specifically, as the polymerizable group, a (meth)acryloyl group, a vinyl group, a styryl group, an allyl group, an epoxy group, an oxetane group and the like are preferable, and a (meth)acryloyl group is more preferable.

(Polymerization Initiator)

The liquid crystal layer-forming composition may contain a polymerization initiator. In particular, in a case where the disk-like liquid crystal compound has a polymerizable group, the liquid crystal layer-forming composition preferably contains a polymerization initiator.

The polymerization initiator is preferably a photopolymerization initiator capable of initiating a polymerization reaction by irradiation with ultraviolet rays. Examples of the photopolymerization initiator include an α-carbonyl compound (described in U.S. Pat. Nos. 2,367,661A and 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. Nos. 3,046,127A and 2,951,758A), a combination of a triaryl imidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), an oxadiazole compound (described in U.S. Pat. No. 4,212,970A), and the like.

The content of the polymerization initiator in the liquid crystal layer-forming composition (the total amount of polymerization initiators in a case where a plurality of polymerization initiators are included) is not particularly limited, but is preferably 0.1% to 20% by mass and more preferably 1.0% to 8.0% by mass with respect to the total mass of the disk-like liquid crystal compound.

(Surfactant)

The liquid crystal layer-forming composition may contain a surfactant that may be unevenly distributed on a surface of the composition layer on the substrate side and/or a surface on the opposite side to the substrate. In a case where the liquid crystal layer-forming composition contains the surfactant, the disk-like compound is likely to be aligned at a desired incidence angle.

Examples of the surfactant include an onium salt compound (described in JP2012-208397A), a boronic acid compound (described in JP2013-54201A), a perfluoroalkyl compound (described in JP4592225B, such as Footer Gent manufactured by Neos Co., Ltd.), a polymer including these functional groups, and the like.

The surfactant may be used singly or in combination of two or more kinds thereof.

A content (the total amount in a case where a plurality of kinds of surfactants are contained) of the surfactant in the liquid crystal layer-forming composition is not particularly limited, but is preferably 0.01% to 10% by mass, more preferably 0.01% to 5.0% by mass, and even more preferably 0.01% to 2.0% by mass with respect to the total mass of the disk-like compounds.

(Solvent)

The liquid crystal layer-forming composition may contain a solvent.

Examples of the solvent include water and organic solvents. Examples of the organic solvents include amides such as N,N-dimethylformamide; sulfoxides such as dimethyl sulfoxide; heterocyclic compounds such as pyridine; hydrocarbons such as benzene and hexane; alkyl halides such as chloroform and dichloromethane, esters such as methyl acetate, butyl acetate, and propylene glycol monoethyl ether acetate; ketones such as acetone, methyl ethyl ketone, cyclohexanone, and cyclopentanone; ethers such as tetrahydrofuran and 1,2-dimethoxyethane; 1,4-butanediol diacetate; and the like. These may be used singly or in combination of two or more kinds thereof

(Other Additives)

The liquid crystal layer-forming composition may include one or two or more types of other additives such as antioxidants, ultraviolet absorbers, sensitizers, stabilizers, plasticizers, chain transfer agents, polymerization inhibitors, defoamers, leveling agents, thickeners, flame retardants, surfactants, dispersants, and colorants such as dyes and pigments.

-Procedure of Step 1-

In the step 1-1, the step of forming the composition layer on the substrate is preferably a step of forming a coating film of the above described liquid crystal layer-forming composition on the substrate.

The coating method is not particularly limited, and examples thereof include a wire bar coating method, an extrusion coating method, a direct gravure coating method, a reverse gravure coating method, a die-coating method, and the like.

As necessary, after applying the liquid crystal layer-forming composition, a drying treatment may be performed on the coating film applied on the substrate. As a result of carrying out the drying treatment, the solvent can be removed from the coating film.

The film thickness of the coating film is not particularly limited, but is preferably 0.1 to 20 μm, more preferably 0.2 to 15 μm, and even more preferably 0.5 to 10 μm.

-Procedure of Step 1-2-

The step 1-2 is preferably a step of allowing the disk-like compound in the composition layer to be in an alignment state by heating the formed coating film.

As a preferable heating condition, it is preferable to heat the composition layer at 40° C. to 150° C. (preferably 60° C. to 100° C.) for 0.5 to 5 minutes (preferably 0.5 to 2 minutes). In a case of heating the composition layer, it is preferable not to heat the composition layer to a temperature at which the liquid crystal compound is in an isotropic phase (Iso). In a case where the composition layer is heated at the temperature at which the disk-like liquid crystal compound becomes an isotropic phase or higher, the number of defects in the tilted and aligned liquid crystal phase increases, which is not preferable.

[Curing Treatment]

In a case where the disk-like liquid crystal compound has a polymerizable group, the composition layer is preferably subjected to a curing treatment.

A method of the curing treatment is not particularly limited, and examples thereof include a photocuring treatment and a thermosetting treatment. Above all, a light irradiation treatment is preferable, and an ultraviolet irradiation treatment is more preferable. In a case where the disk-like liquid crystal compound has a polymerizable group, the curing treatment is preferably a polymerization reaction upon irradiation with light (particularly ultraviolet irradiation), and more preferably a radical polymerization reaction upon irradiation with light (particularly ultraviolet irradiation).

A light source such as an ultraviolet lamp is used for ultraviolet irradiation.

The amount of ultraviolet irradiation energy is not particularly limited, but is generally preferably about 100 to 800 mJ/cm². The time for irradiation with ultraviolet rays is not particularly limited, but may be appropriately determined from the viewpoints of both sufficient strength and productivity of the obtained layer.

[Average Incidence Angle of Disk-like Liquid Crystal Compound and Azimuthal Angle Restriction Power of Tilt Alignment Surface of Liquid Crystal Layer]

In the tilt alignment surface of the liquid crystal layer, an average incidence angle (average tilt angle) of the disk-like liquid crystal compound with respect to the surface of the liquid crystal layer is, for example, preferably 20° to 90°, more preferably 20° to 80°, even more preferably 30° to 80°, and particularly preferably 30° to 65°.

In the observation of the cross-section of the liquid crystal layer with a polarization microscope, the average incidence angle is a value obtained by measuring an angle between a molecular axis of the disk-like liquid crystal compound and a surface of the liquid crystal layer at any five or more points and arithmetically averaging the measured angles.

The average incidence angle of the disk-like liquid crystal compound with respect to the surface of the liquid crystal layer on the tilt alignment surface of the liquid crystal layer can be measured by the observation of the cross-section of the liquid crystal layer with a polarization microscope.

In addition, the tilt alignment surface of the liquid crystal layer has an azimuthal angle restriction power of, for example, 0.00030 J/m² or less, preferably less than 0.00020 J/m², more preferably 0.00010 J/m² or less, and even more preferably 0.00005 J/m² or less. The lower limit is not particularly limited, but is, for example, 0.00000 J/m² or more.

The azimuthal angle restriction power on the tilt alignment surface of the liquid crystal layer can be measured by a method described in J. Appl. Phys. 1992, 33, L1242.

There is an advantage that by the adjustment of the incidence angle of the disk-like liquid crystal compound on the tilt alignment surface of the liquid crystal layer, the incidence angle of the molecular axis of the liquid crystal compound in the cholesteric liquid crystal layer with respect to the main surface is easily adjusted to a predetermined angle. That is, in a case where the above described cholesteric liquid crystal layer 28 (see FIGS. 2 and 3) is exemplified, there is an advantage that the average angle θ₃ of the molecular axes L₁ of the liquid crystal compounds 44 in the cholesteric liquid crystal layer 28 with respect to the main surface 41 is easily adjusted.

By the adjustment of the azimuthal angle restriction power on the tilt alignment surface of the liquid crystal layer, the direction of the molecular axis of each liquid crystal compound on the main surface of the cholesteric liquid crystal layers easily changes while continuously rotating in one direction in the plane. That is, in the case where the above described cholesteric liquid crystal layer 28 (see FIGS. 2 and 3) is exemplified, by the adjustment of the azimuthal angle restriction power on the tilt alignment surface of the liquid crystal layer, the liquid crystal compounds 44 are arranged along the plurality of arrangement axes D₁ parallel to each other on the X-Y plane, and on each arrangement axis D₁, the direction of the molecular axis L₁ of each liquid crystal compound 44 easily changes while continuously rotating in one direction along the arrangement axis D₁ in the plane.

[Step 2]

The step 2 is a step of forming a cholesteric liquid crystal layer on the liquid crystal layer using a composition including a liquid crystal compound. Hereinafter, the step 2 will be described.

The step 2 preferably includes a step 2-1 and a step 2-2 described below.

Step 2-1:

a step of forming a composition layer satisfying the following condition 1 or the following condition 2 on the liquid crystal layer formed in the step 1

Condition 1: at least a part of the liquid crystal compound in the composition layer is tilted and aligned with respect to a surface of the composition layer.

Condition 2: the liquid crystal compound is aligned such that a tilt angle of the liquid crystal compound in the composition layer continuously changes along a thickness direction.

Step 2-2:

a step of forming a cholesteric liquid crystal layer by carrying out a treatment for cholesteric alignment of the liquid crystal compound in the composition layer

The steps 2-1 and 2-2 will be described below.

-Action Mechanism of Step 2-1-

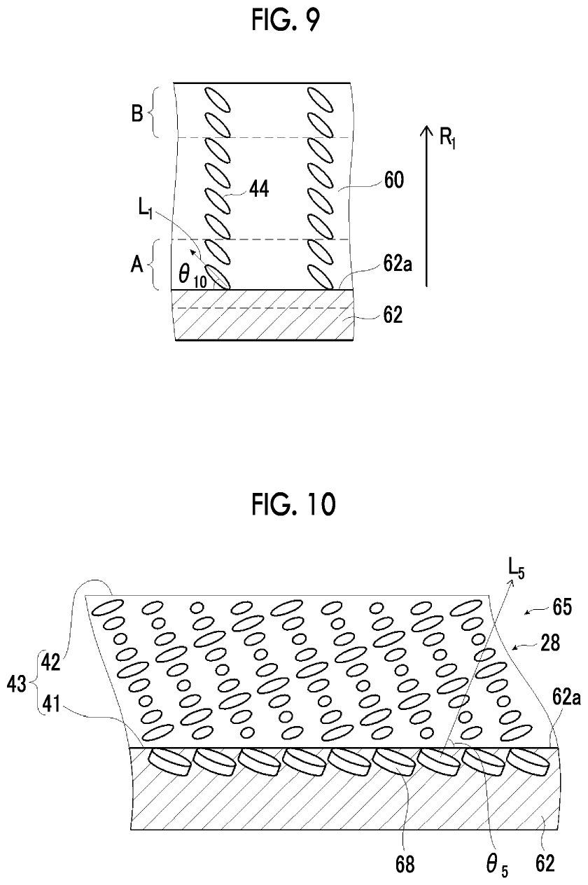

First, FIG. 9 is a schematic cross-sectional diagram of a composition layer that is obtained in step 2-1 and satisfies the condition 1. The liquid crystal compounds 44 shown in FIG. 9 are rod-like liquid crystal compounds.

As shown in FIG. 9, a composition layer 60 is formed on a liquid crystal layer 62 formed using the disk-like liquid crystal compound. The liquid crystal layer 62 includes a tilt alignment surface 62a in which the molecular axis of the disk-like liquid crystal compound is tilted with respect to a surface of the liquid crystal layer 62 (see FIG. 10), on a surface in contact with the composition layer 60.

As shown in FIG. 9, in the composition layer 60 disposed on the tilt alignment surface 62a of the liquid crystal layer 62, the liquid crystal compounds 44 are loosely aligned and restricted by the tilt alignment surface 62a, so that the liquid crystal compounds 44 are aligned to be tilted with respect to the tilt alignment surface 62a. In other words, in the composition layer 60, the liquid crystal compounds 44 are aligned in a certain direction (uniaxial direction) so that a predetermined angle θ₁₀ is formed between the molecular axis L₁ of each liquid crystal compound 44 and the surface of the composition layer 60.

In FIG. 9, the embodiment in which the liquid crystal compounds 44 are aligned over the entire region of the composition layer 60 in the thickness direction R₁ so that the predetermined angle θ₁₀ is formed between the molecular axis L₁ and the tilt alignment surface 62a is illustrated. In this case, as the composition layer that is obtained in the step 2-1 and satisfies the condition 1, a part of the liquid crystal compounds 44 may be tilted and aligned, in at least one of the surface of the composition layer 60 on the tilt alignment surface 62a side (corresponding to region A in FIG. 9) or the surface of the composition layer 60 opposite to the tilt alignment surface 62a side (corresponding to region B in FIG. 9), the liquid crystal compounds 44 are preferably aligned so that the predetermined angle θ₁₀ is formed between the molecular axis L₁ and the surface of the composition layer 60, and the liquid crystal compounds 44 are more preferably aligned to be tilted so that the predetermined angle θ₁₀ is formed between the molecular axis L₁ and the surface of the composition layer 60 on the surface of the tilt alignment surface 62a side.

In a case where the liquid crystal compounds 44 are aligned so that the predetermined angle θ₁₀ is formed between the molecular axis L₁ and the surface of the composition layer 60 in at least any one of the region A or region B, cholesteric alignment of the liquid crystal compounds 44 in the other region can be induced by the alignment restriction power based on the liquid crystal compound 44 aligned on the region A and/or the region B in a case where the liquid crystal compounds 44 are in a state of cholesteric liquid crystalline phase in the following step 2-2.

Although not shown, the composition layer satisfying the above described condition 2 corresponds to a layer in which the liquid crystal compounds 44 are hybrid-aligned with respect to the surface of the composition layer 60, in the composition layer 60 shown in FIG. 9. That is, in the above description of FIG. 9, the composition layer satisfying the above described condition 2 corresponds to an aspect in which the angle θ₁₀ continuously changes in the thickness direction. Specifically, the liquid crystal compounds 44 are aligned so that the tilt angle θ₁₀ (an angle formed between the molecular axis L₁ and the surface of the composition layer 60) continuously changes along a thickness direction R₁ of the composition layer 60.

As the composition layer that is obtained in the step 2-1 and satisfies the condition 2, a part of the liquid crystal compounds 44 may be hybrid-aligned. Regarding the composition layer that is obtained in the step 2-1 and satisfies the condition 2, in at least one of the surface of the composition layer 60 on the tilt alignment surface 62a side (corresponding to region A in FIG. 9) or the surface of the composition layer 60 opposite to the tilt alignment surface 62a side (corresponding to region B in FIG. 9), the liquid crystal compounds 44 are preferably hybrid-aligned with respect to the tilt alignment surface 62a, and the liquid crystal compounds 44 are more preferably hybrid-aligned with respect to the surface of the composition layer 60 on the tilt alignment surface 62a side surface.

The angle θ10 is not particularly limited as long as the angle is not 0° in the entire composition layer (in a case where the angle θ₁₀ is 0° in the entire composition layer, the molecular axis L₁ of each liquid crystal compound 44 is parallel to the tilt alignment surface 62a in a case where the liquid crystal compounds 44 are rod-like liquid crystal compounds). In other words, it is not prevented that the angle θ₁₀ in some regions of the composition layer is 0°.

The angle θ₁₀ is, for example, 0° to 90°. Above all, the angle θ₁₀ is preferably 0° to 50°, and more preferably 0° to 10°.

The composition layer obtained in the step 2-1 is preferably a composition layer satisfying the condition 1 or 2, and more preferably a composition layer satisfying the condition 2 from the viewpoint that the reflection anisotropy of the more excellent cholesteric liquid crystal layer is obtained.

-Action Mechanism of Step 2-2-

After the composition layer satisfying the condition 1 or 2 is obtained in the step 2-1, the liquid crystal compounds in the composition layer are aligned in a cholesteric state in the step 2-2 (in other words, the liquid crystal compounds are formed to be the cholesteric liquid crystalline phase) to form a cholesteric liquid crystal layer.

As a result, a cholesteric liquid crystal layer as shown in FIG. 10 (the cholesteric liquid crystal layer 28 shown in FIGS. 2 and 3) is obtained.

A laminate 65 shown in FIG. 10 includes a liquid crystal layer 62 formed using disk-like liquid crystal compounds 68, and the cholesteric liquid crystal layer 28 disposed to be in contact with the liquid crystal layer 62.

The liquid crystal layer 62 includes the tilt alignment surface 62a in which a molecular axis L₅ of each disk-like liquid crystal compound 68 is tilted with respect to the surface of the liquid crystal layer 62, on a surface in contact with the cholesteric liquid crystal layer 28. That is, on the tilt alignment surface 62a, the molecular axis L₅ of each disk-like liquid crystal compound 68 is aligned to be tilted with respect to the surface of the liquid crystal layer 62. The surface of the liquid crystal layer 62 also corresponds to the main surface 41 and main surface 42 (the X-Y plane) of the cholesteric liquid crystal layer 28.

In the tilt alignment surface 62a of the liquid crystal layer 62, an average incidence angle θ₄ of the disk-like liquid crystal compounds 68 with respect to the surface of the liquid crystal layer 62 is, for example, preferably 20° to 90°, more preferably 20° to 80°, even more preferably 30° to 80°, and particularly preferably 30° to 65°. The average incidence angle θ₄ of the disk-like liquid crystal compounds 68 with respect to the surface of the liquid crystal layer 62 is, in other words, an average angle value of the angles θ₅ formed between the surface of the liquid crystal layer 62 and the disk-like liquid crystal compounds 68.

The average incidence angle θ₅ formed between the disk-like liquid crystal compounds 68 and the surface of the liquid crystal layer 62 on the tilt alignment surface 62a of the liquid crystal layer 62 can be measured by the observation of the cross-section of the liquid crystal layer with a polarization microscope. In the observation of the cross-section of the liquid crystal layer with a polarization microscope, the average incidence angle is a value obtained by measuring an angle between the molecular axis L₅ of each disk-like liquid crystal compound 68 and the surface of the liquid crystal layer 62 at any five or more points and arithmetically averaging the measured angles.

In addition, the tilt alignment surface 62a of the liquid crystal layer 62 has an azimuthal angle restriction power of, for example, 0.00030 J/m² or less, preferably less than 0.00020 J/m², more preferably 0.00010 J/m² or less, and even more preferably 0.00005 J/m² or less. The lower limit is not particularly limited, but is, for example, 0.00000 J/m² or more.

The azimuthal angle restriction power on the tilt alignment surface 62a of the liquid crystal layer 62 can be measured by a method described in J. Appl. Phys. 1992, 33, L1242.

Although it is described in FIG. 10 that a helical axis of the cholesteric liquid crystal layer and the molecular axis of each disk-like liquid crystal compound are tilted in an opposite direction, the tilt directions may be the same as each other.

In addition, in the laminate 65, it is sufficient that the alignment state of the disk-like liquid crystal compounds 68 is retained in the layer, and the composition in the layer no longer needs to exhibit liquid crystallinity.

-Action Mechanism of Liquid Crystal Composition-

As one of methods for achieving the method of forming a cholesteric liquid crystal layer, the present inventors have found a method of using a liquid crystal composition including a chiral agent X whose helical twisting power (HTP) changes due to irradiation with light or a chiral agent Y having a helical twisting power changed depending on a temperature change. Hereinafter, the action mechanism of the liquid crystal composition including the chiral agent X and the action mechanism of the liquid crystal composition including the chiral agent Y will be described in detail.

The helical twisting power (HTP) of the chiral agent is a factor indicating the helical alignment ability represented by Expression (1A).

HTP=1/(length of helical pitch (unit: μm)×concentration of chiral agent in liquid crystal composition (% by mass)) [μm⁻¹] Expression (1A)

The value of HTP is influenced not only by the type of chiral agent but also by the type of liquid crystal compound contained in the composition. Therefore, for example, in a case where a composition including a predetermined chiral agent X and a liquid crystal compound A and a composition including a predetermined chiral agent X and a liquid crystal compound B different from the liquid crystal compound A are prepared, and HTPs of both compositions are measured at the same temperature, the values of HTPs thus measured may be different therebetween.

The helical twisting power (HTP) of the chiral agent is also represented by Expression (1B).

HTP=(average refractive index of liquid crystal compound)/{(concentration of chiral agent in liquid crystal composition (% by mass))×(central reflection wavelength (nm))} [μm⁻¹] Expression (1B)

In a case where the liquid crystal composition includes two or more kinds of chiral agents, the “concentration of chiral agent in liquid crystal composition” in Expressions (1A) and (1B) corresponds to the sum of the concentrations of all the chiral agents.

(Action Mechanism of Liquid Crystal Composition Including Chiral Agent X)

Hereinafter, a method of forming a cholesteric liquid crystal layer using a liquid crystal composition including the chiral agent X will be described.

In a case where the cholesteric liquid crystal layer is formed using the liquid crystal composition including the chiral agent X, a composition layer satisfying the condition 1 or the condition 2 is formed in the step 2-1, and then the composition layer is subjected to a light irradiation treatment in the step 2-2, and thereby, the liquid crystal compound in the composition layer is aligned in a cholesteric state. That is, in the step 2-2, the helical twisting power of the chiral agent X in the composition layer is changed to align the liquid crystal compound in the composition layer in a cholesteric state by the light irradiation treatment.

Here, in a case where the liquid crystal compound in the composition layer is aligned in a cholesteric liquid crystalline phase state, the helical twisting power that induces the helix of the liquid crystal compound is considered to roughly correspond to a weighted average helical twisting power of the chiral agents included in the composition layer. The weighted average helical twisting power here is represented by Expression (1C), for example, in a case where two types of chiral agents (chiral agent A and chiral agent B) are used in combination.

Weighted average helical twisting power (μm⁻¹)=(helical twisting power of chiral agent A (μm⁻¹)×concentration of chiral agent A in liquid crystal composition (% by mass)+helical twisting power of chiral agent B) (μm⁻¹)×concentration of chiral agent B in liquid crystal composition (% by mass))/(concentration of chiral agent A in liquid crystal composition (% by mass)+concentration of chiral agent B in liquid crystal composition (% by mass)) Expression (1C)

However, in Expression (1C), in a case where a helical direction of the chiral agent is dextrorotatory, the helical twisting power has a positive value. In addition, in a case where the helical direction of the chiral agent is levorotatory, the helical twisting power has a negative value. That is, in a case of a chiral agent having a helical twisting power of 10 μm⁻¹, the helical twisting power is represented as 10 μm⁻¹ in a case where the helical direction of the helix induced by the chiral agent is dextrorotatory, for example. On the other hand, in a case where the helical direction of the helix induced by the chiral agent is levorotatory, the helical twisting power is represented as −10 μm⁻¹.

The weighted average helical twisting power (μm⁻¹) obtained by Expression (1C) can also be calculated from Expression (1A) and Expression (1B).

Hereinafter, for example, the weighted average helical twisting power in a case where the composition layer includes the chiral agent A and the chiral agent B that have the following characteristics will be described.

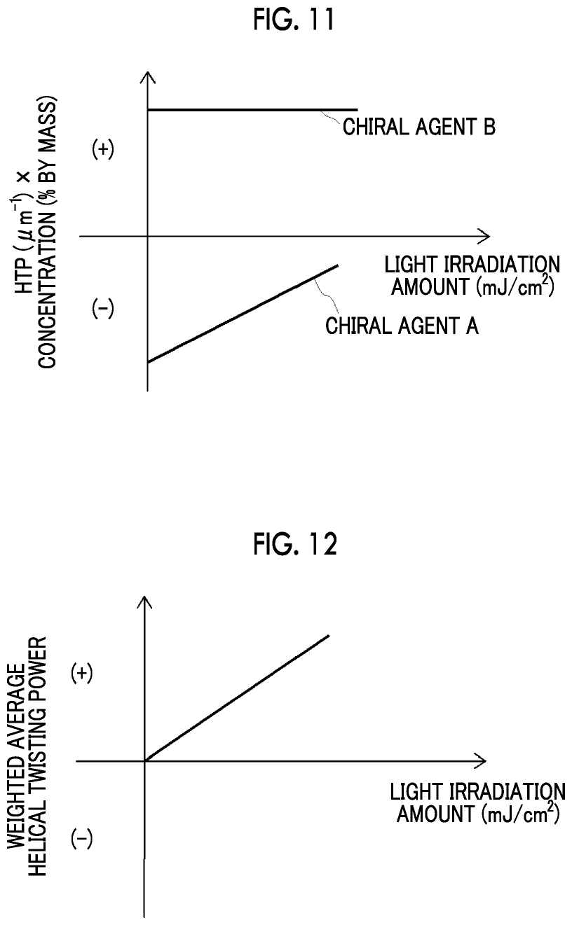

As shown in FIG. 11, the chiral agent A is a chiral agent that corresponds to the chiral agent X, has a levorotatory (−) helical twisting power, and reduces the helical twisting power depending on irradiation with light.

In addition, as shown in FIG. 11, the chiral agent B is a chiral agent having a dextrorotatory (+) helical twisting power opposite to that of the chiral agent A, and having a helical twisting power that is not changed depending on irradiation with light. Here, “helical twisting power of chiral agent A (μm⁻¹)×concentration of chiral agent A (% by mass)” and “helical twisting power of chiral agent B (μm⁻¹)×concentration of chiral agent B (% by mass)” during no light irradiation treatment are equal. In addition, in FIG. 11, with regard to the “helical twisting power of chiral agent (μm⁻¹)×concentration (% by mass) of chiral agent” on the vertical axis, the helical twisting power increases as the value thereof deviates from zero.

In a case where the composition layer includes the chiral agent A and the chiral agent B, the helical twisting power that induces the helix of the liquid crystal compound matches the weighted average helical twisting power of the chiral agent A and the chiral agent B. As a result, in a system in which the chiral agent A and the chiral agent B are used in combination, as shown in FIG. 12, it is considered that a larger light irradiation amount leads to an increase in the helical twisting power that induces the helix of the liquid crystal compound in the direction (+) of the helix induced by the chiral agent B (corresponding to a chiral agent Y).

In the method of forming a cholesteric liquid crystal layer of the present embodiment, an absolute value of the weighted average helical twisting power of the chiral agent in the composition layer formed in the step 2-1 is not particularly limited, but from the viewpoint of easy formation of the composition layer, it is preferably, for example, 0.0 to 1.9 μm⁻¹, more preferably 0.0 to 1.5 μm⁻¹, even more preferably 0.0 to 0.5 μm⁻¹, and most preferably zero (see FIG. 11). On the other hand, in the light irradiation treatment of the step 2-2, the absolute value of the weighted average helical twisting power of the chiral agent in the composition layer is not particularly limited as long as the liquid crystal compound can be aligned in a cholesteric state, but is preferably, for example, 10.0 μm⁻¹ or more, more preferably 10.0 to 200.0 μm⁻¹, and even more preferably 20.0 to 200.0 μm⁻¹.

That is, in the step 2-1, the helical twisting power of the chiral agent X in the composition layer is offset to almost zero, and therefore the liquid crystal compound in the composition layer can be aligned into tilt alignment or hybrid alignment. Next, the light irradiation treatment in the step 2-2 is used as a trigger to change the helical twisting power of the chiral agent X such that the weighted average helical twisting power of the chiral agent in the composition layer is increased either in the dextrorotatory (+) or in the levorotatory (−), and thereby, the cholesteric liquid crystal layer (for example, the cholesteric liquid crystal layer 28) can be obtained.

(Action Mechanism of Liquid Crystal Composition Including Chiral Agent Y)

Next, a method of forming a cholesteric liquid crystal layer using a liquid crystal composition including the chiral agent Y will be described.

In a case where the cholesteric liquid crystal layer is formed using the liquid crystal composition including the chiral agent Y, a composition layer satisfying the condition 1 or the condition 2 is formed in the step 2-1, and then the composition layer is subjected to a cooling treatment or a heating treatment in the step 2-2, and thereby, the liquid crystal compound in the composition layer is aligned in a cholesteric state. That is, in the step 2-2, the helical twisting power of the chiral agent Y in the composition layer is changed to align the liquid crystal compound in the composition layer in a cholesteric state by the cooling treatment or the heating treatment.

As described above, in a case where the liquid crystal compound in the composition layer is aligned in a cholesteric liquid crystalline phase state, the helical twisting power that induces the helix of the liquid crystal compound is considered to roughly correspond to a weighted average helical twisting power of the chiral agents included in the composition layer. The weighted average helical twisting power here is as described above.

Hereinafter, the action mechanism of the chiral agent Y will be described by taking an embodiment in which the liquid crystal compound in the composition layer is aligned in a cholesteric state by carrying out the cooling treatment in the step 2-2 as an example.

First, in the following, for example, the weighted average helical twisting power in a case where the composition layer includes the chiral agent A and the chiral agent B that have the following characteristics will be described.

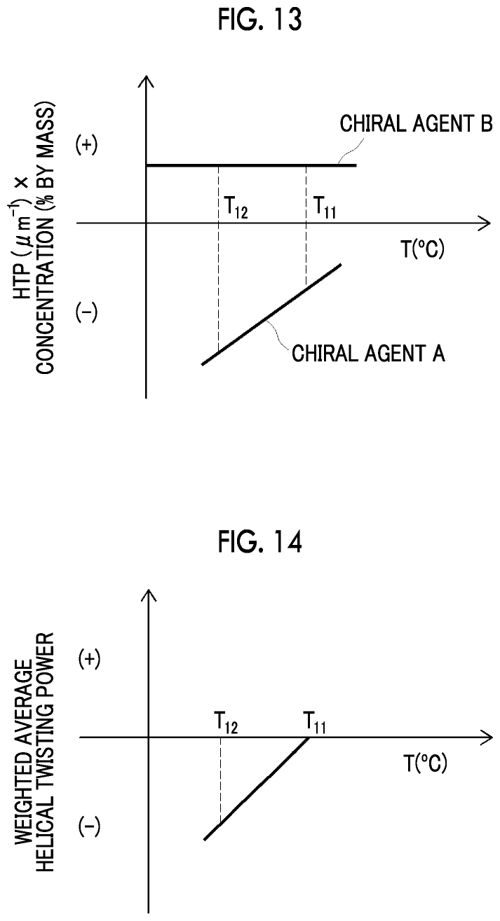

As shown in FIG. 13, the chiral agent A corresponds to the chiral agent Y and is a chiral agent which has a levorotatory (−) helical twisting power at a temperature T₁₁ at which an alignment treatment of the liquid crystal compound for forming the composition layer that satisfies the condition 1 or the condition 2 is carried out in the step 1 and at a temperature T₁₂ at which the cooling treatment in the step 2-2 is carried out and whose levorotatory (−) helical twisting power is increased as the temperature is within a lower region. In addition, as shown in FIG. 13, the chiral agent B is a chiral agent having a dextrorotatory (+) helical twisting power opposite to that of the chiral agent A, and having a helical twisting power that is not changed depending on the temperature change. Here, “helical twisting power of chiral agent A (μm⁻¹)×concentration of chiral agent A (% by mass)” and “helical twisting power of chiral agent B (μm⁻¹)×concentration of chiral agent B (% by mass)” at the temperature T₁₁ are equal.

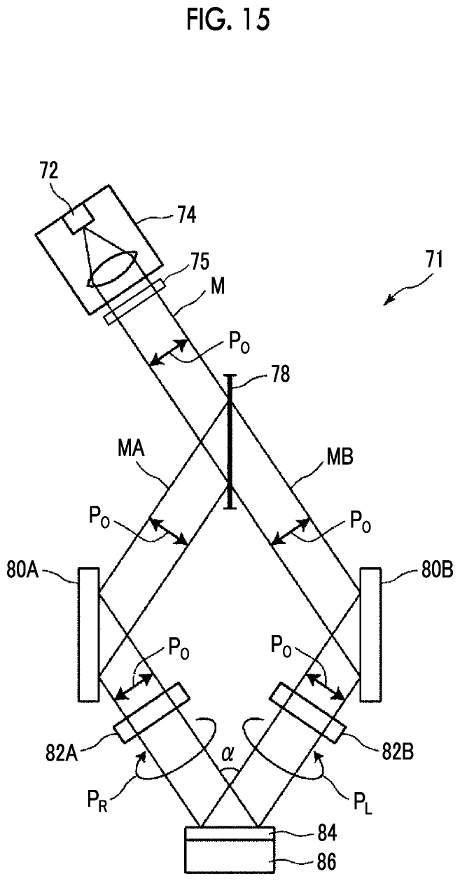

In a case where the composition layer includes the chiral agent A and the chiral agent B, the helical twisting power that induces the helix of the liquid crystal compound matches the weighted average helical twisting power of the chiral agent A and the chiral agent B. As a result, in a system in which the chiral agent A and the chiral agent B are used in combination, as shown in FIG. 14, it is considered that the lower temperature region leads to an increase in the helical twisting power that induces the helix of the liquid crystal compound in the direction (−) of the helix induced by the chiral agent A (corresponding to the chiral agent Y).

In the method of forming a cholesteric liquid crystal layer of the present embodiment, the absolute value of the weighted average helical twisting power of the chiral agent in the composition layer is not particularly limited, but in a case of forming a composition layer satisfying the condition 1 or the condition 2 in the step 2-1 (that is, in a case of the present embodiment, at the temperature T₁₁ at which an alignment treatment of a liquid crystal compound for forming a composition layer satisfying the condition 1 or the condition 2 is carried out), it is preferably 0.0 to 1.9 μm⁻¹, more preferably 0.0 to 1.5 μm⁻¹, even more preferably 0.0 to 0.5 μm⁻¹, and most preferably zero, from the viewpoint of easy formation of the composition layer.

On the other hand, at the temperature T₁₂ at which the cooling treatment in the step 2-2 is carried out, the absolute value of the weighted average helical twisting power of the chiral agent in the composition layer is not particularly limited as long as the liquid crystal compound can be aligned in a cholesteric state, but is preferably 10.0 μm⁻¹ or more, more preferably 10.0 to 200.0 μm⁻¹, and even more preferably 20.0 to 200.0 μm⁻¹ (see FIG. 14).

That is, at the temperature T₁₁, since the helical twisting power of the chiral agent Y is offset to almost zero, the liquid crystal compound can be brought into tilt alignment or hybrid alignment. Next, the cooling treatment or the heating treatment (temperature change to temperature T₁₂) in the step 2-2 is used as a trigger to increase the helical twisting power of the chiral agent Y such that the weighted average helical twisting power of the chiral agent in the composition layer is increased either in the dextrorotatory (+) or in the levorotatory (−), and thereby, the cholesteric liquid crystal layer (for example, the cholesteric liquid crystal layer 28) can be obtained.

-Procedure of Step 2-

Hereinafter, the procedure of the step 2 will be described in detail. In the following, an aspect in which a liquid crystal composition including the chiral agent X is used and an aspect in which a liquid crystal composition including the chiral agent Y is used will be separately described in detail.

(Aspect Using Liquid Crystal Composition Including Chiral Agent X)

Hereinafter, the procedure of the step 2 using the liquid crystal composition including the chiral agent X (hereinafter, also referred to as a “step 2X”) will be described.

The step 2X includes at least a step 2X-1 and a step 2X-2 described below.

Step 2X-1: a step of forming a composition layer satisfying the following condition 1 or the following condition 2 on a liquid crystal layer by using a liquid crystal composition including a chiral agent X and a liquid crystal compound

Step 2X-2: a step of forming a cholesteric liquid crystal layer by the composition layer being subjected to a light irradiation treatment to result in cholesteric alignment of the liquid crystal compound in the composition layer

Condition 1: at least a part of the liquid crystal compound in the composition layer is tilted and aligned with respect to a surface of the composition layer.

Condition 2: the liquid crystal compound is aligned such that a tilt angle of the liquid crystal compound in the composition layer continuously changes along a thickness direction.

In a case where the liquid crystal compound has a polymerizable group, the composition layer is preferably subjected to a curing treatment in the step 2X as described later.

Hereinafter, the materials used in each step and the procedure of each step will be described in detail.

<<Step 2X-1>>

The step 2X-1 is a step of forming a composition layer satisfying the above condition 1 or the above condition 2 on a liquid crystal layer by using a liquid crystal composition including the chiral agent X and the liquid crystal compound (hereinafter, also referred to as a “composition X”).

Hereinafter, the composition X will be described in detail, and then the procedure of the step will be described in detail.

<<<<Composition X>>>>

The composition X includes the liquid crystal compound and the chiral agent X having a helical twisting power changed depending on irradiation with light. Hereinafter, each component will be described.

As described above, the absolute value of the weighted average helical twisting power of the chiral agent in the composition layer obtained in the step 2X-1 is preferably 0.0 to 1.9 μm⁻¹, more preferably 0.0 to 1.5 μm⁻¹, even more preferably 0.0 to 0.5 μm⁻¹, and most preferably zero, from the viewpoint of easy formation of the composition layer. Therefore, in a case where the chiral agent X has a helical twisting power exceeding the above described predetermined range in a state of no light irradiation treatment, it is preferable that the composition X includes a chiral agent that induces a helix in a direction opposite to that of the chiral agent X (hereinafter, also referred to as a “chiral agent XA”), and the helical twisting power of the chiral agent X is offset to almost zero in the step 2X-1 (that is, the weighted average helical twisting power of the chiral agent in the composition layer obtained in the step 2X-1 is set to the above predetermined range). It is more preferable that the chiral agent XA is a compound that does not change the helical twisting power by the light irradiation treatment.

In addition, in a case where the liquid crystal composition includes a plurality of chiral agents X as the chiral agent and a case where the weighted average helical twisting power of the plurality of chiral agents X is a helical twisting power outside the above described predetermined range in a state of no light irradiation treatment, “another chiral agent XA that induces a helix in a direction opposite to that of the chiral agent X” is intended to mean a chiral agent that induces a helix in a direction opposite to that of the weighted average helical twisting power of the plurality of chiral agents X.

In a case where the chiral agent X is used singly, has no helical twisting power in a state of no light irradiation treatment, and has a property of increasing a helical twisting power depending on irradiation with light, the chiral agent XA may not be used in combination therewith.

Liquid Crystal Compound

The type of the liquid crystal compound is not particularly limited.

Generally, liquid crystal compounds can be classified into a rod-like type (rod-like liquid crystal compound) and a disk-like type (discotic liquid crystal compound or disk-like liquid crystal compound) depending on the shape thereof. Furthermore, the rod-like type and the disk-like type are each classified into a low molecular weight type and a high molecular weight type. The high molecular weight generally refers to having a polymerization degree of 100 or more (Polymer Physics-Phase Transition Dynamics, Masao Doi, page 2, Iwanami Shoten, 1992). Any liquid crystal compound can be used in the present invention. In addition, two or more liquid crystal compounds may be used in combination.

The liquid crystal compound may have a polymerizable group. The type of the polymerizable group is not particularly limited, a functional group capable of an addition polymerization reaction is preferable, and a polymerizable ethylenically unsaturated group or a ring-polymerizable group is more preferable. More specifically, the polymerizable group is preferably a (meth)acryloyl group, a vinyl group, a styryl group, an allyl group, an epoxy group, or an oxetane group, and more preferably a (meth)acryloyl group.

A liquid crystal compound represented by Formula (I) is suitably used as the liquid crystal compound.

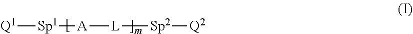

In Formula,

A represents a phenylene group which may have a substituent or a trans-1,4-cyclohexylene group which may have a substituent, at least one of A's represents a trans-1,4-cyclohexylene group which may have a substituent,

L represents a single bond or a linking group selected from the group consisting of —CH₂O—, —OCH₂—, —(CH₂)₂OC(═O)—, —C(═O)O(CH₂)₂—, —C(═O)O—, —OC(═O)—, —OC(═O)O—, —CH═N—N═CH—, —CH═CH—, —C≡C—, —NHC(═O)—, —C(═O)NH—, —CH═N—, —N═CH—, —CH═CH—C(═O)O—, and —OC(═O)—CH═CH—,

m represents an integer of 3 to 12,

Sp¹ and Sp² each independently represent a single bond or a linking group selected from the group consisting of a linear or branched alkylene group having 1 to 20 carbon atoms and a group in which one or two or more —CH₂— in a linear or branched alkylene group having 1 to 20 carbon atoms is substituted with —O—, —S—, —NH—, —N(CH₃)—, —C(═O)—, —OC(═O)—, or —C(═O)O—, and

Q¹ and Q² each independently represent a hydrogen atom or a polymerizable group selected from the group consisting of groups represented by Formula (Q-1) to Formula (Q-5), provided that one of Q¹ and Q² represents a polymerizable group.

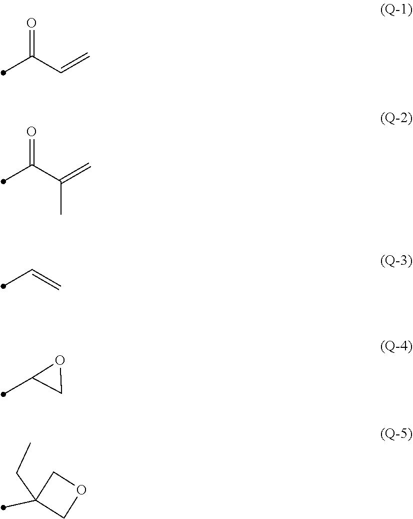

A is a phenylene group which may have a substituent or a trans-1,4-cyclohexylene group which may have a substituent. In the present specification, the phenylene group is preferably a 1,4-phenylene group.

At least one of A's is a trans-1,4-cyclohexylene group which may have a substituent.

m pieces of A's may be the same as or different from each other.

m represents an integer of 3 to 12, preferably an integer of 3 to 9, more preferably an integer of 3 to 7, and even more preferably an integer of 3 to 5.

The substituent which the phenylene group and the trans-1,4-cyclohexylene group in Formula (I) may have is not particularly limited, and examples thereof include substituents selected from the group consisting of an alkyl group, a cycloalkyl group, an alkoxy group, an alkyl ether group, an amide group, an amino group, a halogen atom, and a group formed by combining two or more of these substituents. In addition, examples of the substituent include substituents represented by —C(═O)—X³-Sp³-Q³ described later. The phenylene group and the trans-1,4-cyclohexylene group may have 1 to 4 substituents. In a case where the phenylene group and the trans-1,4-cyclohexylene group have two or more substituents, two or more substituents may be the same as or different from each other.

In the present specification, the alkyl group may be either linear or branched. The number of carbon atoms in the alkyl group is preferably 1 to 30, more preferably 1 to 10, and even more preferably 1 to 6. Examples of the alkyl group include a methyl group, an ethyl group, an n-propyl group, an isopropyl group, an n-butyl group, an isobutyl group, a sec-butyl group, a tert-butyl group, an n-pentyl group, an isopentyl group, a neopentyl group, a 1,1-dimethylpropyl group, an n-hexyl group, an isohexyl group, a heptyl group, an octyl group, a nonyl group, a decyl group, an undecyl group, and a dodecyl group. The explanation of the alkyl group in the alkoxy group is also the same as the explanation on the foregoing alkyl group. In the present specification, specific examples of the alkylene group in a case of being referred to as an alkylene group include divalent groups obtained by removing any one hydrogen atom from each of the above examples of the alkyl group. Examples of the halogen atom include a fluorine atom, a chlorine atom, a bromine atom, and an iodine atom.

In the present specification, the number of carbon atoms in the cycloalkyl group is preferably 3 or more and more preferably 5 or more and is preferably 20 or less, more preferably 10 or less, even more preferably 8 or less, and particularly preferably 6 or less. Examples of the cycloalkyl group include a cyclopropyl group, a cyclobutyl group, a cyclopentyl group, a cyclohexyl group, a cycloheptyl group, and a cyclooctyl group.

The substituent which the phenylene group and the trans-1,4-cyclohexylene group may have is preferably a substituent selected from the group consisting of an alkyl group, an alkoxy group, and —C(═O)—X³-Sp³-Q³. Here, X³ represents a single bond, —O—, —S—, or —N(Sp⁴-Q⁴)-, or represents a nitrogen atom forming a ring structure together with Q³ and Sp³. Sp³ and Sp⁴ each independently represent a single bond or a linking group selected from the group consisting of a linear or branched alkylene group having 1 to 20 carbon atoms and a group in which one or two or more —CH₂— in a linear or branched alkylene group having 1 to 20 carbon atoms is substituted with —O—, —S—, —NH—, —N(CH₃)—, —C(═O)—, —OC(═O)—, or —C(═O)O—.

Q³ and Q⁴ each independently represent a hydrogen atom, a cycloalkyl group, a group in which one or two or more —CH₂— is substituted with —O—, —S—, —NH—, —N(CH₃)—, —C(═O)—, —OC(═O)—, —C(═O)O— in a cycloalkyl group, or any other polymerizable group selected from the group consisting of a group represented by Formulae (Q-1) to (Q-5).

Specific examples of the group in which one or two or more —CH₂— in a cycloalkyl group is substituted with —O—, —S—, —NH—, —N(CH₃)—, —C(═O)—, —OC(═O)—, or C(═O)O— include a tetrahydrofuranyl group, a pyrrolidinyl group, an imidazolidinyl group, a pyrazolidinyl group, a piperidyl group, a piperazinyl group, and a morpholinyl group. Among these, a tetrahydrofuranyl group is preferable, and a 2-tetrahydrofuranyl group is more preferable.

In Formula (I), L represents a single bond or a linking group selected from the group consisting of —CH₂O—, —OCH₂—, —(CH₂)₂OC(═O)—, —C(═O)O(CH₂)₂—, —C(═O)O—, —OC(═O)—, —OC(═O)O—, —CH═CH—C(═O)O—, and —OC(═O)—CH═CH—. L is preferably —C(═O)O— or —OC(═O)—. m pieces of L's may be the same as or different from each other.

Sp¹ and Sp² each independently represent a single bond or a linking group selected from the group consisting of a linear or branched alkylene group having 1 to 20 carbon atoms and a group in which one or two or more —CH₂— in a linear or branched alkylene group having 1 to 20 carbon atoms is substituted with —O—, —S—, —NH—, —N(CH₃)—, —C(═O)—, —OC(═O)—, or —C(═O)O—. Sp¹ and Sp² are each independently preferably a linking group formed by combining one or two or more groups selected from the group consisting of a linear alkylene group having 1 to 10 carbon atoms to which a linking group selected from the group consisting of —O—, —OC(═O)—, and —C(═O)O— is bonded to both terminals thereof, —OC(═O)—, —C(═O)O—, —O—, and a linear alkylene group having 1 to 10 carbon atoms, and more preferably a linear alkylene group having 1 to 10 carbon atoms to which —O— is bonded to both terminals thereof.

Q¹ and Q² each independently represent a hydrogen atom or a polymerizable group selected from the group consisting of groups represented by Formulae (Q-1) to (Q-5). However, either Q¹ or Q² represents a polymerizable group.

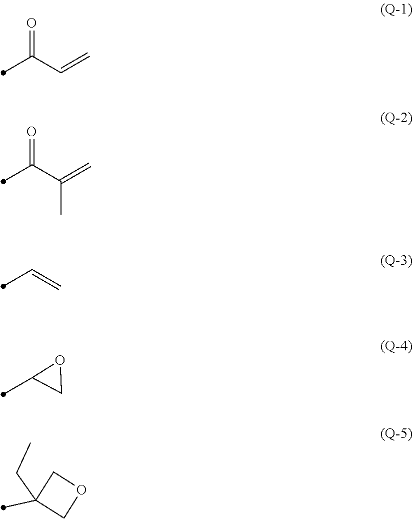

The polymerizable group is preferably an acryloyl group (Formula (Q-1)) or a methacryloyl group (Formula (Q-2)).

Specific examples of the liquid crystal compound include a liquid crystal compound represented by Formula (I-11), a liquid crystal compound represented by Formula (I-21), and a liquid crystal compound represented by Formula (I-31). In addition to the above compounds, known compounds such as a compound represented by Formula (I) in JP2013-112631A, a compound represented by Formula (I) in JP2010-70543A, a compound represented by Formula (I) in JP2008-291218A, a compound represented by Formula (I) in JP4725516B, a compound represented by General Formula (II) in JP2013-087109A, a compound described in paragraph [0043] of JP2007-176927A, a compound represented by Formula (1-1) in JP2009-286885A, a compound represented by General Formula (I) in WO2014/10325A, a compound represented by Formula (1) in JP2016-81035A, and a compound represented by Formulae (2-1) and (2-2) in JP2016-121339A can be mentioned.

Liquid crystal compound represented by Formula (I-11)

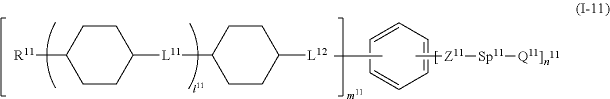

In Formula, R¹¹ represents a hydrogen atom, a linear or branched alkyl group having 1 to 12 carbon atoms, or —Z¹²-Sp¹²-Q¹²,

L¹¹ represents a single bond, —C(═O)O—, or —O(C═O)—,

L¹² represents —C(═O)O—, —OC(═O)—, or —CONR²—,

R² represents a hydrogen atom or an alkyl group having 1 to 3 carbon atoms,

Z¹¹ and Z¹² each independently represent a single bond, —O—, —NH—, —N(CH₃)—, —S—, —C(═O)O—, —OC(═O)—, —OC(═O)O—, or —C(═O)NR¹²—,

R¹² represents a hydrogen atom or Sp¹²-Q¹²,

Sp¹¹ and Sp¹² each independently represent a single bond, a linear or branched alkylene group having 1 to 12 carbon atoms which may be substituted with Q¹¹, or a linking group obtained by substituting one or more —CH₂— in a linear or branched alkylene group having 1 to 12 carbon atoms which may be substituted with Q¹¹ with —O—, —S—, —NH—, —N(Q¹¹)-, or —C(═O)—,

Q¹¹ represents a hydrogen atom, a cycloalkyl group, a group where one or more —CH₂— in a cycloalkyl group is substituted with —O—, —S—, —NH—, —N(CH₃)—, —C(═O)—, —OC(═O)—, or —C(═O)O—, or a polymerizable group selected from the group consisting of groups represented by Formula (Q-1) to Formula (Q-5),

Q¹² represents a hydrogen atom or a polymerizable group selected from the group consisting of groups represented by Formula (Q-1) to Formula (Q-5),

l¹¹ represents an integer of 0 to 2,

m¹¹ represents an integer of 1 or 2,

n¹¹ represents an integer of 1 to 3, and

a plurality of R¹¹'s, a plurality of L¹¹'s, a plurality of L¹²'s, a plurality of l¹¹'s, a plurality of Z¹¹'s, a plurality of Sp¹¹'s, and a plurality of Q¹¹'s may be respectively the same as or different from each other.

In addition, the liquid crystal compound represented by Formula (I-11) contains at least one —Z¹²-Sp¹²-Q¹² in which Q¹² is a polymerizable group selected from the group consisting of groups represented by Formula (Q-1) to Formula (Q-5), as R¹¹.

In addition, the liquid crystal compound represented by Formula (I-11) is preferably —Z¹¹-Sp¹¹-Q¹¹ in which Z¹¹ is —C(═O)O— or —C(═O)NR¹²— and Q¹¹ is a polymerizable group selected from the group consisting of groups represented by Formula (Q-1) to Formula (Q-5). Furthermore, in the liquid crystal compound represented by Formula (I-11), R¹¹ is preferably —Z¹²-Sp¹²-Q¹² in which Z¹² is —C(═O)O— or —C(═O)NR¹²—, and Q¹² is a polymerizable group selected from the group consisting of groups represented by Formula (Q-1) to Formula (Q-5).

Any 1,4-cyclohexylene group contained in the liquid crystal compound represented by Formula (I-11) is a trans-1,4-cyclohexylene group.

A suitable aspect of the liquid crystal compound represented by Formula (I-11) may be, for example, a compound in which L″ is a single bond, l¹¹ is 1-(a dicyclohexyl group), and Q¹¹ is a polymerizable group selected from the group consisting of groups represented by Formula (Q-1) to Formula (Q-5).

Another suitable aspect of the liquid crystal compound represented by Formula (I-11) may be, for example, a compound in which m¹¹ is 2, l¹¹ is 0, and two R¹¹'s each represent —Z¹²-Sp¹²-Q¹², and Q¹² is a polymerizable group selected from the group consisting of groups represented by Formula (Q-1) to Formula (Q-5).

Liquid Crystal Compound Represented by Formula (I-21)

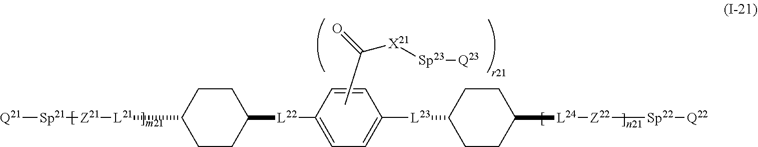

In Formula, Z²¹ and Z²² each independently represent a trans-1,4-cyclohexylene group which may have a substituent or a phenylene group which may have a substituent,

the above substituents are each independently 1 to 4 substituents selected from the group consisting of —CO—X²¹-Sp²³-Q²³, an alkyl group, and an alkoxy group,

m21 represents an integer of 1 or 2, and n21 represents an integer of 0 or 1,

in a case where m21 represents 2, n21 represents 0,

in a case where m21 represents 2, two Z²¹'s may be the same or different,

at least one of Z²¹ or Z²² is a phenylene group which may have a substituent,

L²¹, L²², L²³, and L²⁴ each independently represent a single bond or a linking group selected from the group consisting of —CH₂O—, —OCH₂—, —(CH₂)₂OC(═O)—, —C(═O)O(CH₂)₂—, —C(═O)O—, —OC(═O)—, —OC(═O)O—, —CH═CH—C(═O)O—, and —OC(═O)—CH═CH—,

X²¹ represents —O—, —S—, or —N(Sp²⁵-Q²⁵)- or represents a nitrogen atom forming a ring structure together with Q²³ and Sp²³,

r²¹ represents an integer of 1 to 4,

Sp²¹, Sp²², Sp²³, and Sp²⁵ each independently represent a single bond or a linking group selected from the group consisting of a linear or branched alkylene group having 1 to 20 carbon atoms and a group where one or two or more —CH₂— in a linear or branched alkylene group having 1 to 20 carbon atoms is substituted with —O—, —S—, —NH—, —N(CH₃)—, —C(═O)—, —OC(═O)—, or —C(═O)O—,

Q²¹ and Q²² each independently represent a polymerizable group selected from the group consisting of groups represented by Formula (Q-1) to Formula (Q-5),

Q²³ represents a hydrogen atom, a cycloalkyl group, a group where one or two or more —CH₂— in a cycloalkyl group is substituted with —O—, —S—, —NH—, —N(CH₃)—, —C(═O)—, —OC(═O)—, or —C(═O)O—, any one polymerizable group selected from the group consisting of groups represented by Formula (Q-1) to Formula (Q-5), or a single bond in a case where X²¹ is a nitrogen atom forming a ring structure together with Q²³ and Sp²³, and

Q²⁵ represents a hydrogen atom, a cycloalkyl group, a group where one or two or more —CH₂— in a cycloalkyl group is substituted with —O—, —S—, —NH—, —N(CH₃)—, —C(═O)—, —OC(═O)—, or —C(═O)O—, or any polymerizable group selected from the group consisting of groups represented by Formula (Q-1) to Formula (Q-5), provided that in a case where Sp²⁵ is a single bond, Q²⁵ is not a hydrogen atom.

It is preferable that the liquid crystal compound represented by Formula (I-21) has a structure in which a 1,4-phenylene group and a trans-1,4-cyclohexylene group are alternately present. For example, preferred is a structure in which m21 is 2, n21 is 0, and Z²¹ is a trans-1,4-cyclohexylene group which may have a substituent or an arylene group which may have a substituent, each of which from the Q²¹ side, or a structure in which m21 is 1, n21 is 1, Z²¹ is an arylene group which may have a substituent, and Z²² is an arylene group which may have a substituent.

Liquid Crystal Compound Represented by Formula (I-31)

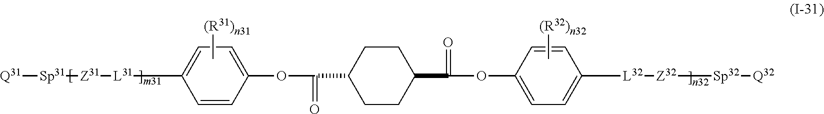

In Formula, R³¹ and R³² each independently represent an alkyl group, an alkoxy group, and a group selected from the group consisting of —C(═O)—X³¹-Sp³³-Q³³,

n31 and n32 each independently represent an integer of 0 to 4,

X³¹ represents a single bond, —O—, —S—, or —N(Sp³⁴-Q³⁴)- or represents a nitrogen atom forming a ring structure together with Q³³ and Sp³³,

Z³¹ represents a phenylene group which may have a substituent,

Z³² represents a trans-1,4-cyclohexylene group which may have a substituent or a phenylene group which may have a substituent,

the above substituents are each independently 1 to 4 substituents selected from the group consisting of an alkyl group, an alkoxy group, and —C(═O)—X³¹-Sp³³-Q³³,

m31 represents an integer of 1 or 2, and m32 represents an integer of 0 to 2, in a case where m31 and m32 represent 2, two Z³¹'s and Z³²'s may be the same or different,

L³¹ and L³² each independently represent a single bond or a linking group selected from the group consisting of —CH₂O—, —OCH₂—, —(CH₂)₂OC(═O)—, —C(═O)O(CH₂)₂—, —C(═O)O—, —OC(═O)—, —OC(═O)O—, —CH═CH—C(═O)O—, and —OC(═O)—CH═CH—,

Sp³¹, Sp³², Sp³³, and Sp³⁴ each independently represent a single bond or a linking group selected from the group consisting of a linear or branched alkylene group having 1 to 20 carbon atoms and a group where one or two or more —CH₂— in a linear or branched alkylene group having 1 to 20 carbon atoms is substituted with —O—, —S—, —NH—, —N(CH₃)—, —C(═O)—, —OC(═O)—, or —C(═O)O—,

Q³¹ and Q³² each independently represent any polymerizable group selected from the group consisting of groups represented by Formula (Q-1) to Formula (Q-5), and

Q³³ and Q³⁴ each independently represent a hydrogen atom, a cycloalkyl group, a group where one or two or more —CH₂— in a cycloalkyl group is substituted with —O—, —S—, —NH—, —N(CH₃)—, —C(═O)—, —OC(═O)—, or —C(═O)O—, or any polymerizable group selected from the group consisting of groups represented by Formula (Q-1) to Formula (Q-5), provided that Q³³ may represent a single bond in a case of forming a ring structure together with X³¹ and Sp³³, and Q³⁴ is not a hydrogen atom in a case where Sp³⁴ is a single bond.

As the liquid crystal compound represented by Formula (I-31), examples of particularly preferable compounds include a compound in which Z³² is a phenylene group and a compound in which m32 is 0.

It is also preferable that the compound represented by Formula (I) has a partial structure represented by Formula (II).

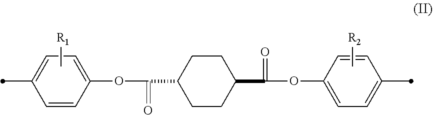

In Formula (II), black circles indicate the bonding positions with other moieties of Formula (I). The partial structure represented by Formula (II) may be included as a part of the partial structure represented by Formula (III) in Formula (I).

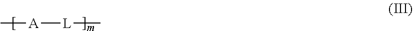

In Formula, R¹ and R² are each independently a group selected from the group consisting of a hydrogen atom, an alkyl group, an alkoxy group, and a group represented by —C(═O)—X³-Sp³-Q³. Here, X³ represents a single bond, —O—, —S—, or —N(Sp⁴-Q⁴)-, or represents a nitrogen atom forming a ring structure together with Q³ and Sp³. X³ is preferably a single bond or —O—. R¹ and R² are preferably —C(═O)—X³-Sp³-Q³. In addition, it is also preferable that R¹ and R² are the same. The bonding position of each of R¹ and R² to the phenylene group is not particularly limited.

Sp³ and Sp⁴ each independently represent a single bond or a linking group selected from the group consisting of a linear or branched alkylene group having 1 to 20 carbon atoms and a group in which one or two or more —CH₂— in a linear or branched alkylene group having 1 to 20 carbon atoms is substituted with —O—, —S—, —NH—, —N(CH₃)—, —C(═O)—, —OC(═O)—, or —C(═O)O—. Sp³ and Sp⁴ are each independently preferably a linear or branched alkylene group having 1 to 10 carbon atoms, more preferably a linear alkylene group having 1 to 5 carbon atoms, and even more preferably a linear alkylene group having 1 to 3 carbon atoms.

Q³ and Q⁴ each independently represent a hydrogen atom, a cycloalkyl group, a group where one or two or more —CH₂— in a cycloalkyl group is substituted with —O—, —S—, —NH—, —N(CH₃)—, —C(═O)—, —OC(═O)—, or —C(═O)O—, or any polymerizable group selected from the group consisting of groups represented by Formula (Q-1) to Formula (Q-5).

It is also preferable that the compound represented by Formula (I) has, for example, a structure represented by Formula (II-2).

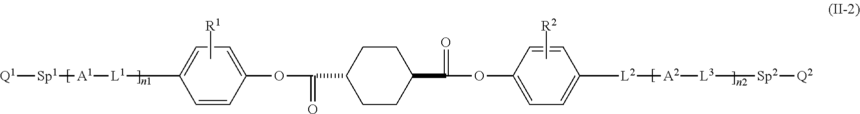

In Formula, A¹ and A² each independently represent a phenylene group which may have a substituent or a trans-1,4-cyclohexylene group which may have a substituent, and the above substituents are each independently 1 to 4 substituents selected from the group consisting of an alkyl group, an alkoxy group, and —C(═O)—X³-Sp³-Q³,

L¹, L², and L³ each represent a single bond or a linking group selected from the group consisting of —CH₂O—, —OCH₂—, —(CH₂)₂OC(═O)—, —C(═O)O(CH₂)₂—, —C(═O)O—, —OC(═O)—, —OC(═O)O—, —CH═CH—C(═O)O—, and —OC(═O)—CH═CH—, and

n1 and n2 each independently represent an integer of 0 to 9, and n1+n2 is 9 or less.

Each of Q¹, Q², Sp¹, and Sp² has the same definition as that of each group in Formula (I). Each of X³, Sp³, Q³, R¹, and R² has the same definition as that of each group in Formula (II).

As the liquid crystal compound for use in the present invention, a compound represented by Formula (IV) and described in JP2014-198814A, in particular, a polymerizable liquid crystal compound having one (meth)acrylate group represented by Formula (IV) is also suitably used.

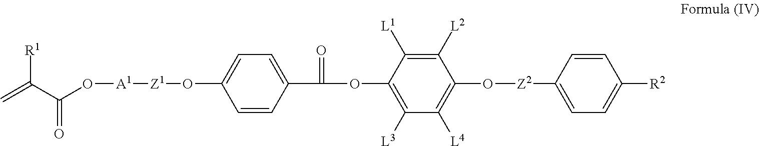

In Formula (IV), A¹ represents an alkylene group having 2 to 18 carbon atoms, in which one CH₂ or two or more non-adjacent CH₂'s in the alkylene group may be substituted with —O—;

Z¹ represents —C(═O)—, —O—C(═O)—, or a single bond;

Z² represents —C(═O)— or —C(═O)—CH═CH—;

R¹ represents a hydrogen atom or a methyl group;

R² represents a hydrogen atom, a halogen atom, a linear alkyl group having 1 to 4 carbon atoms, a methoxy group, an ethoxy group, a phenyl group which may have a substituent, a vinyl group, a formyl group, a nitro group, a cyano group, an acetyl group, an acetoxy group, an N-acetylamide group, an acryloylamino group, an N,N-dimethylamino group, a maleimide group, a methacryloylamino group, an allyloxy group, an allyloxycarbamoyl group, an N-alkyloxycarbamoyl group in which the alkyl group has 1 to 4 carbon atoms, an N-(2-methacryloyloxyethyl)carbamoyloxy group, an N-(2-acryloyloxyethyl)carbamoyloxy group, or a structure represented by Formula (IV-2); and

L¹, L², L³, and L⁴ each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom, and at least one of L¹, L², L³, or L⁴ represents a group other than a hydrogen atom.

—Z⁵-T-Sp-P Formula (IV-2)

In Formula (IV-2), P represents an acryloyl group, a methacryl group, or a hydrogen atom, and Z⁵ represents a single bond, —C(═O)O—, —OC(═O)—, —C(═O)NR¹— (R¹ represents a hydrogen atom or a methyl group), —NR¹C(═O)—, —C(═O)S—, or —SC(═O)—, T represents 1,4-phenylene, and Sp represents a divalent aliphatic group having 1 to 12 carbon atoms which may have a substituent, in which one CH₂ or two or more non-adjacent CH₂'s in the aliphatic group may be substituted with —O—, —S—, —OC(═O)—, —C(═O)O—, or —OC(═O)O—.

The compound represented by Formula (IV) is preferably a compound represented by Formula (V).

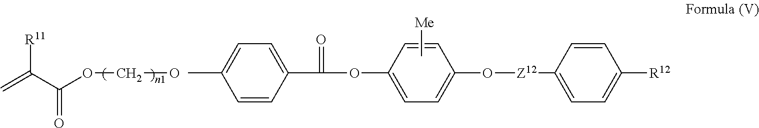

In Formula (V), n1 represents an integer of 3 to 6;

R¹¹ represents a hydrogen atom or a methyl group;

Z¹² represents —C(═O)— or —C(═O)—CH═CH—; and

R¹² represents a hydrogen atom, a linear alkyl group having 1 to 4 carbon atoms, a methoxy group, an ethoxy group, a phenyl group, an acryloylamino group, a methacryloylamino group, an allyloxy group, or a structure represented by Formula (IV-3).

—Z⁵¹-T-Sp-P Formula (IV-3)

In Formula (IV-3), P represents an acryloyl group or a methacryl group;

Z⁵¹ represents —C(═O)O— or —OC(═O)—; T represents 1,4-phenylene; and

Sp represents a divalent aliphatic group having 2 to 6 carbon atoms which may have a substituent. One CH₂ or two or more non-adjacent CH₂'s in this aliphatic group may be substituted with —O—, —OC(═O)—, —C(═O)O—, or —OC(═O)O—.

n1 represents an integer of 3 to 6, and is preferably 3 or 4.

A¹² represents —C(═O)— or —C(═O)—CH═CH— and preferably represents —C(═O)—.

R¹² is a hydrogen atom, a linear alkyl group having 1 to 4 carbon atoms, a methoxy group, an ethoxy group, a phenyl group, an acryloylamino group, a methacryloylamino group, an allyloxy group, or a group represented by Formula (IV-3), preferably represents a methyl group, an ethyl group, a propyl group, a methoxy group, an ethoxy group, a phenyl group, an acryloylamino group, a methacryloylamino group, or a group represented by Formula (IV-3), and more preferably represents a methyl group, an ethyl group, a methoxy group, an ethoxy group, a phenyl group, an acryloylamino group, a methacryloylamino group, or a structure represented by Formula (IV-3).

As the liquid crystal compound for use in the present invention, a compound represented by Formula (VI) and described in JP2014-198814A, in particular, a liquid crystal compound having no (meth)acrylate group represented by Formula (VI) is also suitably used.

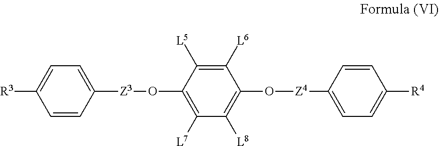

In Formula (VI), Z³ represents —C(═O)— or —CH═CH—C(═O)—;

Z⁴ represents —C(═O)— or —C(═O)—CH═CH—;

R³ and R⁴ each independently represent a hydrogen atom, a halogen atom, a linear alkyl group having 1 to 4 carbon atoms, a methoxy group, an ethoxy group, an aromatic ring which may have a substituent, a cyclohexyl group, a vinyl group, a formyl group, a nitro group, a cyano group, an acetyl group, an acetoxy group, an acryloylamino group, an N,N-dimethylamino group, a maleimide group, a methacryloylamino group, an allyloxy group, an allyloxycarbamoyl group, an N-alkyloxycarbamoyl group in which the alkyl group has 1 to carbon atoms, an N-(2-methacryloyloxyethyl)carbamoyloxy group, an N-(2-acryloyloxyethyl)carbamoyloxy group, or a structure represented by Formula (VI-2); and

L⁵, L⁶, L⁷, and L⁸ each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom, and at least one of L⁵, L⁶, L⁷, or L⁸ represents a group other than a hydrogen atom.

—Z⁵-T-Sp-P Formula (VI-2)

In Formula (VI-2), P represents an acryloyl group, a methacryl group, or a hydrogen atom, Z⁵ represents —C(═O)O—, —OC(═O)—, —C(═O)NR¹— (R¹ represents a hydrogen atom or a methyl group), —NR¹C(═O)—, —C(═O)S—, or —SC(═O)—, T represents 1,4-phenylene, and Sp represents a divalent aliphatic group having 1 to 12 carbon atoms which may have a substituent. However, one CH₂ or two or more non-adjacent CH₂'s in this aliphatic group may be substituted with —O—, —S—, —OC(═O)—, —C(═O)O—, or —OC(═O)O—.

The compound represented by Formula (VI) is preferably a compound represented by Formula (VII).

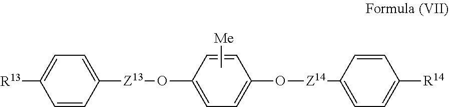

In Formula (VII), Z¹³ represents —C(═O)— or —C(═O)—CH═CH—;

Z¹⁴ represents —C(═O)— or —CH═CH—C(═O)—; and

R¹³ and R¹⁴ each independently represent a hydrogen atom, a linear alkyl group having 1 to 4 carbon atoms, a methoxy group, an ethoxy group, a phenyl group, an acryloylamino group, a methacryloylamino group, an allyloxy group, or a structure represented by Formula (IV-3).

Z¹³ represents —C(═O)— or —C(═O)—CH═CH— and is preferably —C(═O)—.

R¹³ and R¹⁴ each independently represent a hydrogen atom, a linear alkyl group having 1 to 4 carbon atoms, a methoxy group, an ethoxy group, a phenyl group, an acryloylamino group, a methacryloylamino group, an allyloxy group, or a structure represented by Formula (IV-3), preferably represents a methyl group, an ethyl group, a propyl group, a methoxy group, an ethoxy group, a phenyl group, an acryloylamino group, a methacryloylamino group, or a structure represented by Formula (IV-3), and more preferably represents a methyl group, an ethyl group, a methoxy group, an ethoxy group, a phenyl group, an acryloylamino group, a methacryloylamino group, or a structure represented by Formula (IV-3).

As the liquid crystal compound for use in the present invention, a compound represented by Formula (VIII) and described in JP2014-198814A, in particular, a polymerizable liquid crystal compound having two (meth)acrylate groups represented by Formula (VIII) is also suitably used.

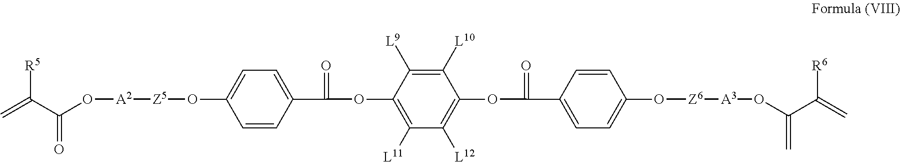

In Formula (VIII), A² and A³ each independently represent an alkylene group having 2 to 18 carbon atoms, and one CH₂ or two or more non-adjacent CH₂'s in the alkylene group may be substituted with —O—;

Z⁵ represents —C(═O)—, —OC(═O)—, or a single bond;

Z⁶ represents —C(═O)—, —C(═O)O—, or a single bond;

R⁵ and R⁶ each independently represent a hydrogen atom or a methyl group; and

L⁹, L¹⁰, L¹¹, and L¹² each independently represent an alkyl group having 1 to 4 carbon atoms, an alkoxy group having 1 to 4 carbon atoms, an alkoxycarbonyl group having 2 to 5 carbon atoms, an acyl group having 2 to 4 carbon atoms, a halogen atom, or a hydrogen atom, and at least one of L⁹, L¹⁰, L¹¹, or L¹² represents a group other than a hydrogen atom.

The compound represented by Formula (VIII) is preferably a compound represented by Formula (IX).

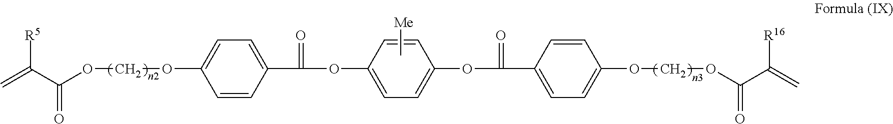

In Formula (IX), n2 and n3 each independently represent an integer of 3 to 6; and

R¹⁵ and R¹⁶ each independently represent a hydrogen atom or a methyl group.

In Formula (IX), it is preferable that n2 and n3 each independently represent an integer of 3 to 6, and n2 and n3 are 4.

In Formula (IX), it is preferable that R¹⁵ and R¹⁶ each independently represent a hydrogen atom or a methyl group, and R¹⁵ and R¹⁶ each represent a hydrogen atom.

Such liquid crystal compounds can be produced by a known method.

In order to obtain a composition layer satisfying the above condition 1 and condition 2, it is preferable to use a liquid crystal compound having a large pretilt angle at an interface.

•Chiral Agent X Having Helical Twisting Power Changed Depending on Irradiation with Light

The chiral agent X is a compound that induces a helix of a liquid crystal compound, and is not particularly limited as long as it is a chiral agent having a helical twisting power (HTP) changed depending on irradiation with light.

In addition, the chiral agent X may have liquid crystallinity or non-liquid crystallinity. The chiral agent X generally contains an asymmetric carbon atom. However, an axial asymmetric compound or planar asymmetric compound not containing an asymmetric carbon atom can also be used as the chiral agent X. The chiral agent X may have a polymerizable group.

The chiral agent X may be, for example, a so-called photoreactive chiral agent. The photoreactive chiral agent is a compound that has a chiral moiety and a photoreactive moiety that undergoes a structural change upon irradiation with light, and greatly changes the twisting power of the liquid crystal compound in accordance with the light irradiation amount, for example.

Examples of the photoreactive moiety that undergoes a structural change upon irradiation with light include photochromic compounds (written by Kingo Uchida and Masahiro Irie, Chemical Industry, Vol. 64, p. 640, 1999, and written by Kingo Uchida and Masahiro Irie, Fine Chemical, Vol. 28(9), p. 15, 1999). In addition, the structural change means decomposition, addition, isomerization, dimerization, or the like caused upon irradiation with light to the photoreactive moiety, and the structural change may be irreversible. In addition, the chiral moiety corresponds to an asymmetric carbon described in Chemistry of Liquid Crystal, No. 22, Hiroyuki Nohira, Chemistry Review, p. 73, 1994.

Examples of the photoreactive chiral agent include photoreactive chiral agents described in paragraphs 0044 to 0047 of JP2001-159709A, optically active compounds described in paragraphs 0019 to 0043 of JP2002-179669A, optically active compounds described in paragraphs 0020 to 0044 of JP2002-179633A, optically active compounds described in paragraphs 0016 to 0040 of JP2002-179670A, optically active compounds described in paragraphs 0017 to 0050 of JP2002-179668A, optically active compounds described in paragraphs 0018 to 0044 of JP2002-180051A, optically active compounds described in paragraphs 0016 to 0055 of JP2002-338575A, and optically active compounds in paragraphs 0020 to 0049 of JP2002-179682A.

Above all, a compound having at least one photoisomerization moiety is preferably used as the chiral agent X. From the viewpoint that absorption of visible light is small, photoisomerization easily occurs, and the difference in the helical twisting power before and after irradiation with light is large, the photoisomerization moiety is preferably a cinnamoyl moiety, a chalcone moiety, an azobenzene moiety, a stilbene moiety, or a coumarin moiety, and more preferably a cinnamoyl moiety or a chalcone moiety. The photoisomerization moiety corresponds to the above described photoreactive moiety that undergoes a structural change upon irradiation with light.

In addition, from the viewpoint that the difference in the helical twisting power before and after irradiation with light is large, the chiral agent X is preferably an isosorbide-based optically active compound, an isomannide-based optical compound, or a binaphthol-based optically active compound. That is, the chiral agent X preferably has an isosorbide skeleton, an isomannide skeleton, or a binaphthol skeleton as the chiral moiety. Above all, from the viewpoint of a larger helical twisting power difference before and after irradiation with light, the chiral agent X is more preferably an isosorbide-based optically active compound or a binaphthol-based optically active compound, and even more preferably an isosorbide-based optically active compound.

Since the helical pitch of the cholesteric liquid crystalline phase depends on the type of the chiral agent X and the added concentration thereof, a desired pitch can be obtained by the adjustment of these factors.

The chiral agent X may be used singly or in combination of two or more kinds thereof.

The total content of the chiral agent in the composition X (the total content of all chiral agents in the composition X) is preferably 2.0% by mass or more and more preferably 3.0% by mass or more with respect to the total mass of the liquid crystal compound. In addition, from the viewpoint of suppressing the haze of the cholesteric liquid crystal layer, the upper limit of the total content of the chiral agent in the composition X is preferably 15.0% by mass or less and more preferably 12.0% by mass or less with respect to the total mass of the liquid crystal compound.

Optional Components

The composition X may include components other than the liquid crystal compound and the chiral agent X.

••Chiral Agent XA

The chiral agent XA is preferably a chiral agent which is a compound that induces a helix of a liquid crystal compound and has a helical twisting power (HTP) that is not changed depending on irradiation with light.

The chiral agent XA may have liquid crystallinity or non-liquid crystallinity. The chiral agent XA generally contains an asymmetric carbon atom. However, an axial asymmetric compound or planar asymmetric compound not containing an asymmetric carbon atom can also be used as the chiral agent XA. The chiral agent XA may have a polymerizable group.

A known chiral agent can be used as the chiral agent XA.

In a case where the liquid crystal composition includes one type of the chiral agent X singly and the chiral agent X has a helical twisting power exceeding a predetermined range (for example, 0.0 to 1.9 μm⁻¹) in a state of no light irradiation treatment, the chiral agent XA is preferably a chiral agent that induces a helix in a direction opposite to that of the above described chiral agent X. That is, for example, in a case where the helix induced by the chiral agent X is dextrorotatory, the helix induced by the chiral agent XA is levorotatory.

In addition, in a case where the liquid crystal composition includes a plurality of chiral agents X as the chiral agent and then the weighted average helical twisting power thereof exceeds the above described predetermined range in a state of no light irradiation treatment, the chiral agent XA is preferably a chiral agent that induces a helix in a direction opposite to that of the above described weighted average helical twisting power.

••Polymerization Initiator

The composition X may include a polymerization initiator. In particular, in a case where the liquid crystal compound has a polymerizable group, the composition X preferably includes a polymerization initiator.

Examples of the polymerization initiator include those similar to the polymerization initiator that may be contained in the liquid crystal layer. The polymerization initiator that may be contained in the liquid crystal layer is as described above.

The content of the polymerization initiator in the composition X (the total amount of polymerization initiators in a case where a plurality of polymerization initiators are included) is not particularly limited, but is preferably 0.1% to 20% by mass and more preferably 1.0% to 8.0% by mass with respect to the total mass of the liquid crystal compound.

••Surfactant

The composition X may include a surfactant that can be unevenly distributed on the surface of the composition layer on the tilt alignment surface 62a side and/or the surface of the composition layer opposite to the tilt alignment surface 62a.

In a case where an alignment control agent contains a surfactant in the composition X, a composition layer satisfying the above condition 1 or the above condition 2 is easily obtained, and therefore, stable or rapid formation of a cholesteric liquid crystalline phase is possible.

Examples of the surfactant include those similar to the surfactant that may be contained in the liquid crystal layer. The surfactant that may be contained in the liquid crystal layer is as described above.

Above all, the composition X preferably includes a surfactant (for example, an onium salt compound (as described in JP2012-208397A)) capable of controlling the tilt angle (see FIG. 9) of the molecular axis L₁ of the liquid crystal compound 44 with respect to the tilt alignment surface 62a on a surface of the tilt alignment surface 62a side in the composition layer formed in the step 2X-1, and a surfactant (for example, a polymer having a perfluoroalkyl group in the side chain thereof) capable of controlling the tilt angle (see FIG. 9) of the molecular axis L₁ of the liquid crystal compound 44 with respect to the tilt alignment surface 62a on the surface opposite to the tilt alignment surface 62a side. In addition, in a case where the composition X includes the above described surfactant, the obtained cholesteric liquid crystal layer also has an advantage that the haze is small.

The surfactant may be used singly or in combination of two or more kinds thereof.

The content of the surfactant in the composition X is not particularly limited, but is preferably 0.01% to 10% by mass, more preferably 0.01% to 5.0% by mass, and even more preferably 0.01% to 2.0% by mass with respect to the total mass of the liquid crystal compound. The content of the surfactant is the total amount thereof in a case where a plurality of surfactants are contained.

••Solvent

The composition X may include a solvent.

Examples of the solvent include those similar to the solvent that may be contained in the liquid crystal layer. The solvent that may be contained in the liquid crystal layer is as described above.

••Other Additives

The composition X may contain one or two or more other additives such as antioxidants, ultraviolet absorbers, sensitizers, stabilizers, plasticizers, chain transfer agents, polymerization inhibitors, defoamers, leveling agents, thickeners, flame retardants, surfactants, dispersants, and colorants such as dyes and pigments.

It is preferable that one or more of the compounds constituting the composition X are compounds having a plurality of polymerizable groups (polyfunctional compound). Furthermore, the total content of the compounds having a plurality of polymerizable groups in the composition X is preferably 80% by mass or more with respect to the total solid content in the composition X. The solid content is a component that forms the cholesteric liquid crystal layer, and a solvent is not contained therein.

By making 80% by mass or more of the total solid content in the composition X a compound having a plurality of polymerizable groups, it is preferable that the structure of the cholesteric liquid crystalline phase can be firmly immobilized and durability can be imparted.

The compound having a plurality of polymerizable groups is a compound having two or more immobilizable groups in one molecule. In the present invention, the polyfunctional compound included in the composition X may or may not have liquid crystallinity.

<<<<Procedure of Step 2X-1>>>>

The step 2X-1 preferably includes a step 2X-1-1 and a step 2X-1-2 described below.

Step 2X-1-1: a step of bringing the composition X into contact with the liquid crystal layer to form a coating film on the liquid crystal layer

Step 2X-1-2: a step of heating the coating film to form a composition layer satisfying the above condition 1 or the above condition 2

•Step 2X-1-1: Step of Forming Coating Film

In the step 2X-1-1, the composition X described above is first applied onto a liquid crystal layer. The coating method is not particularly limited, and examples thereof include a wire bar coating method, an extrusion coating method, a direct gravure coating method, a reverse gravure coating method, a die-coating method, and the like. Prior to application of the composition X, a known rubbing treatment may be applied to the liquid crystal layer.

As necessary, a treatment for drying the coating film applied onto the liquid crystal layer may be carried out after application of the composition X. As a result of carrying out the drying treatment, the solvent can be removed from the coating film.

The film thickness of the coating film is not particularly limited, but is preferably 0.1 to 20 μm, more preferably 0.2 to 15 μm, and even more preferably 0.5 to 10 μm from the viewpoint that reflection anisotropy and haze of the cholesteric liquid crystal layer are more excellent.

•Step 2X-1-2: Step of Forming Composition Layer

The liquid crystal phase transition temperature of the composition X is preferably within a range of 10° C. to 250° C. and more preferably within a range of 10° C. to 150° C., from the viewpoint of formation suitability.

As preferable heating conditions, the composition layer is preferably heated at 40° C. to 100° C. (preferably 60° C. to 100° C.) for 0.5 to 5 minutes (preferably 0.5 to 2 minutes).

In a case of heating the composition layer, it is preferable not to heat the composition layer to a temperature at which the liquid crystal compound is in an isotropic phase (Iso). In a case where the composition layer is heated at the temperature at which the liquid crystal compounds become an isotropic phase or higher, the number of defects in the tilted and aligned liquid crystal phase or hybrid-aligned liquid crystal phase increases, which is not preferable.

A composition layer satisfying the above condition 1 or the above condition 2 can be obtained by the step 2X-1-2.

In order to make the liquid crystal compound tilt-aligned or hybrid-aligned, it is effective to give a pretilt angle to the interface, and specifically, the following method can be mentioned for this purpose.

(1) An alignment control agent that is unevenly distributed at an air interface and/or a liquid crystal layer interface and controls the alignment of the liquid crystal compound is added to the composition X.

(2) A liquid crystalline compound having a large pretilt angle at the interface is added to the composition X as the liquid crystal compound.

<<Step 2X-2>>

The step 2X-2 is a step in which the composition layer obtained in the step 2X-1 is subjected to a light irradiation treatment to change the helical twisting power of the chiral agent X, and the liquid crystal compound in the composition layer is aligned in a cholesteric state to form a cholesteric liquid crystal layer.

A light irradiation region is divided into a plurality of domains and a light irradiation amount for each domain is adjusted, so that a region having a different helical pitch can be further formed. The regions having different helical pitches are regions having different selective reflection wavelengths.

The irradiation intensity of the light irradiation in the step 2X-2 is not particularly limited and can be appropriately determined based on the helical twisting power of the chiral agent X. In general, the irradiation intensity of light irradiation in the step 2X-2 is preferably about 0.1 to 200 mW/cm². The time for irradiation with light is not particularly limited, but may be appropriately determined from the viewpoints of both sufficient strength and productivity of the obtained layer.

The temperature of the composition layer at the time of irradiation with light is, for example, 0° C. to 100° C., and preferably 10° C. to 60° C.

The light used for light irradiation is not particularly limited as long as it is an actinic ray or radiation that changes the helical twisting power of the chiral agent X, which refers to, for example, an emission line spectrum of a mercury lamp, far ultraviolet rays represented by an excimer laser, extreme ultraviolet rays (EUV light), X-rays, ultraviolet rays, and electron beams (EB). Among these, ultraviolet rays are preferable.

Here, in the method of forming a cholesteric liquid crystal layer described above, in a case where the composition layer is exposed to wind, the surface state of the formed cholesteric liquid crystal layer may be uneven. Considering this point, in the method of forming a cholesteric liquid crystal layer described above, it is preferable that the wind speed of the environment to which the composition layer is exposed is low in all steps of the step 2X. Specifically, in the method of forming a cholesteric liquid crystal layer described above, the wind speed of the environment to which the composition layer is exposed is preferably 1 m/s or less in all steps of the step 2X.

<<Curing Treatment>>

In a case where the liquid crystal compound has a polymerizable group, it is preferable to carry out a curing treatment on the composition layer. Examples of the procedure for carrying out the curing treatment on the composition layer include the following (1) and (2).

A step 3X of (1) carrying out a curing treatment for immobilizing a cholesteric alignment state in the step 2X-2 to form a cholesteric liquid crystal layer in which the cholesteric alignment state is immobilized, that is, carrying out the curing treatment at the same time with the step 2X-2), or

(2) carrying out a curing treatment for immobilizing a cholesteric alignment state after the step 2X-2 to form a cholesteric liquid crystal layer in which the cholesteric alignment state is immobilized is further provided.

That is, the cholesteric liquid crystal layer obtained by carrying out the curing treatment corresponds to a layer formed by the cholesteric liquid crystalline phase being immobilized.

Here, as the state in which the cholesteric liquid crystalline phase is “immobilized”, the most typical and preferred aspect is a state in which the alignment of the liquid crystal compound brought into a cholesteric liquid crystalline phase is retained. The state in which the cholesteric liquid crystalline phase is “immobilized” is not limited thereto, and specifically, the state refers to a state in which, in a temperature range of usually 0° C. to 50° C. and in a temperature range of −30° C. to 70° C. under more severe conditions, this layer has no fluidity and can keep an immobilized alignment state stably without causing changes in alignment state due to external field or external force. In the present invention, as will be described later, it is preferable that the alignment state of a cholesteric liquid crystalline phase is immobilized by a curing reaction proceeding upon irradiation with ultraviolet rays.

In the layer obtained by immobilizing a cholesteric liquid crystalline phase, it is sufficient that the optical properties of the cholesteric liquid crystalline phase are retained in the layer, and finally the composition in the layer no longer needs to exhibit liquid crystallinity.

A method of the curing treatment is not particularly limited, and examples thereof include a photocuring treatment and a thermosetting treatment. Above all, a light irradiation treatment is preferable, and an ultraviolet irradiation treatment is more preferable. In addition, as described above, the liquid crystal compound is preferably a liquid crystal compound having a polymerizable group. In a case where the liquid crystal compound has a polymerizable group, the curing treatment is preferably a polymerization reaction upon irradiation with light (particularly ultraviolet irradiation), and more preferably a radical polymerization reaction upon irradiation with light (particularly ultraviolet irradiation).

A light source such as an ultraviolet lamp is used for ultraviolet irradiation.

The amount of ultraviolet irradiation energy is not particularly limited, but is generally preferably about 100 to 800 mJ/cm². The time for irradiation with ultraviolet rays is not particularly limited, but may be appropriately determined from the viewpoints of both sufficient strength and productivity of the obtained layer.

(Aspect Using Liquid Crystal Composition Including Chiral Agent Y)

Hereinafter, a method of forming a cholesteric liquid crystal layer using a liquid crystal composition including a chiral agent Y (hereinafter, also referred to as a “step 2Y”) will be described.

The formation method 2Y includes at least a step 2Y-1 and a step 2Y-2 described below.

Step 2Y-1: a step of forming a composition layer satisfying the following condition 1 or the following condition 2 on the liquid crystal layer by using a liquid crystal composition including a chiral agent Y and a liquid crystal compound

Step 2Y-2: a step of subjecting the composition layer to a cooling treatment or a heating treatment to result in cholesteric alignment of the liquid crystal compound in the composition layer, thereby forming a cholesteric liquid crystal layer

Condition 1: at least a part of the liquid crystal compound in the composition layer is tilt-aligned with respect to a surface of the composition layer

Condition 2: the liquid crystal compound is aligned such that a tilt angle of the liquid crystal compound in the composition layer continuously changes along a thickness direction.

In a case where the liquid crystal compound has a polymerizable group, in the step 2Y, a curing treatment is preferably carried out on the composition layer as described later.

Hereinafter, the materials used in each step and the procedure of each step will be described in detail.

<<Step 2Y-1>>

The step 2Y-1 is a step of forming a composition layer satisfying the above condition 1 or the above condition 2 on a liquid crystal layer by using a liquid crystal composition including the chiral agent Y and the liquid crystal compound (hereinafter, also referred to as a “composition Y”).

The step 2Y-1 has the same step procedure as that of the step 2X-1 described above, except that the composition Y is used in place of the composition X, and thus the description thereof will not be repeated.

<<<<Composition Y>>>>

The composition Y includes the liquid crystal compound and the chiral agent Y having a helical twisting power changed depending on a temperature change. Hereinafter, each component will be described.

As described above, the absolute value of the weighted average helical twisting power of the chiral agent in the composition layer is, for example, 0.0 to 1.9 μm⁻¹, preferably 0.0 to 1.5 μm⁻¹, more preferably 0.0 to 0.5 μm⁻¹, and even more preferably zero, from the viewpoint of easy formation of the composition layer at the temperature T₁₁ at which an alignment treatment of a liquid crystal compound for forming a composition layer satisfying the above condition 1 or the above condition 2 in the step 2Y-1 is carried out. Therefore, in a case where the chiral agent Y has a helical twisting power exceeding the above described predetermined range at the temperature T₁₁, it is preferable that the composition Y includes a chiral agent that induces a helix in a direction opposite to that of the chiral agent Y (hereinafter, also referred to as a “chiral agent YA”) at the temperature T₁₁, and the helical twisting power of the chiral agent Y is offset to almost zero in the step 2Y-1. The “helical twisting power of the chiral agent Y is offset to almost zero in the step 2Y-1” means that, that is, the weighted average helical twisting power of the chiral agent in the composition layer is set to the above predetermined range. It is preferable that the chiral agent YA has no change in the helical twisting power depending on a temperature change.

In addition, in a case where the liquid crystal composition includes a plurality of chiral agents Y as the chiral agent and a case where the weighted average helical twisting power of the plurality of chiral agents Y is a helical twisting power outside the above described predetermined range at the temperature T₁₁, “another chiral agent YA that induces a helix in a direction opposite to that of the chiral agent Y” is intended to mean a chiral agent that induces a helix in a direction opposite to that of the weighted average helical twisting power of the plurality of chiral agents Y.

In a case where the chiral agent Y alone has no helical twisting power at the temperature T₁₁ and has a property of increasing a helical twisting power depending on a temperature change, the chiral agent YA may not be used in combination therewith.

Hereinafter, various materials included in the composition Y will be described. Among the materials included in the composition Y, components other than the chiral agent are the same as the materials included in the composition X, and thus the description thereof will not be repeated.

•Chiral Agent Y Having Helical Twisting Power Changed Depending on Cooling or Heating

The chiral agent Y is a compound that induces a helix of a liquid crystal compound, and is not particularly limited as long as the chiral agent Y is a chiral agent having a helical twisting power that is increased depending on cooling or heating. The term “cooling or heating” as used herein means a cooling treatment or heating treatment which is carried out in the step 2Y-1. In addition, the upper limit of the cooling or heating temperature is usually about ±150° C. (in other words, a chiral agent whose helical twisting power is increased depending on cooling or heating within ±150° C. is preferable). Above all, a chiral agent whose helical twisting power is increased depending on cooling is preferable.

The chiral agent Y may have liquid crystallinity or non-liquid crystallinity. The chiral agent can be selected from various known chiral agents (for example, Liquid Crystal Device Handbook, Chap. 3, Item 4-3, Chiral Agents for Twisted Nematic (TN) and Super Twisted Nematic (STN), p. 199, edited by the 142nd Committee of the Japan Society for the Promotion of Science, 1989). The chiral agent Y generally contains an asymmetric carbon atom. However, an axial asymmetric compound or planar asymmetric compound not containing an asymmetric carbon atom can also be used as the chiral agent Y. Examples of the axial asymmetric compound or the planar asymmetric compound include binaphthyl, helicene, paracyclophane, and derivatives thereof. The chiral agent Y may have a polymerizable group.

Above all, from the viewpoint that the difference in the helical twisting power after a temperature change is large, the chiral agent Y is preferably an isosorbide-based optically active compound, an isomannide-based optically active compound, or a binaphthol-based optically active compound, and more preferably a binaphthol-based optically active compound.

The total content of the chiral agent in the composition Y (the total content of all chiral agents in the composition Y) is preferably 2.0% by mass or more and more preferably 3.0% by mass or more with respect to the total mass of the liquid crystal compound. In addition, from the viewpoint of suppressing the haze of the cholesteric liquid crystal layer, the upper limit of the total content of the chiral agent in the composition X is preferably 15.0% by mass or less and more preferably 12.0% by mass or less with respect to the total mass of the liquid crystal compound.

A smaller use amount of the chiral agent Y is preferable since it tends not to affect liquid crystallinity. Therefore, the chiral agent Y is preferably a compound having a strong twisting power in order that the compound could achieve desired twisted alignment of a helical pitch even in a case where the used amount thereof is small.

•Chiral Agent YA

The chiral agent YA is preferably a chiral agent which is a compound that induces a helix of a liquid crystal compound and has a helical twisting power (HTP) that is not changed depending on a temperature change.

In addition, the chiral agent YA may have liquid crystallinity or non-liquid crystallinity. The chiral agent XA generally contains an asymmetric carbon atom. However, an axial asymmetric compound or planar asymmetric compound not containing an asymmetric carbon atom can also be used as the chiral agent YA. The chiral agent YA may have a polymerizable group.

A known chiral agent can be used as the chiral agent YA.

In a case where the liquid crystal composition includes one type of the chiral agent Y alone and the chiral agent Y has a helical twisting power exceeding a predetermined range (for example, 0.0 to 1.9 μm⁻¹) at the temperature T₁₁, the chiral agent YA is preferably a chiral agent that induces a helix in a direction opposite to that of the above described chiral agent Y. That is, for example, in a case where the helix induced by the chiral agent Y is dextrorotatory, the helix induced by the chiral agent YA is levorotatory.

In addition, in a case where the liquid crystal composition includes a plurality of chiral agents Y as the chiral agent and a case where the weighted average helical twisting power of the plurality of chiral agents Y exceeds the above described predetermined range at the temperature T₁₁, the chiral agent YA is preferably a chiral agent that induces a helix in a direction opposite to that of the above-mentioned weighted average helical twisting power.

<<Step 2Y-2>>

The step 2Y-2 is a step in which the composition layer obtained in the step 2Y-1 is subjected to a cooling treatment or a heating treatment to change the helical twisting power of the chiral agent Y, and the liquid crystal compound in the composition layer is aligned in a cholesteric state to form a cholesteric liquid crystal layer. Above all, it is preferable to cool the composition layer in the present step.

In a case where the composition layer is cooled, it is preferable to cool the composition layer such that the temperature of the composition layer is lowered by 30° C. or more, from the viewpoint that the reflection anisotropy of the cholesteric liquid crystal layer is more excellent. Above all, from the viewpoint that the above effect is more excellent, it is preferable to cool the composition layer such that the temperature of the composition layer is lowered by 40° C. or more, and more preferable to cool the composition layer such that the temperature of the composition layer is lowered by 50° C. or more. The upper limit value of the reduced temperature range of the cooling treatment is not particularly limited, but is usually about 150° C.

In other words, the cooling treatment is intended to cool the composition layer such that the temperature of the composition layer is T—30° C. or lower, in a case where the temperature of the composition layer satisfying the above condition 1 or the above condition 2 obtained in the step 1 before cooling of the composition layer is T° C. That is, T₁₂≤T₁₁-30° C. in a case of an aspect shown in FIG. 13.

The cooling method is not particularly limited and examples thereof include a method in which a liquid crystal layer on which the composition layer is disposed is left to stand in an atmosphere of a predetermined temperature.

Although there is no limitation on a cooling rate in the cooling treatment, it is preferable to set the cooling rate to a certain rate from the viewpoint that the reflection anisotropy of the cholesteric liquid crystal layer is more excellent.

Specifically, the maximum value of the cooling rate in the cooling treatment is preferably 1° C. or higher per second, more preferably 2° C. or higher per second, and even more preferably 3° C. or higher per second. The upper limit of the cooling rate is not particularly limited and is often 10° C. or lower per second.

Here, in the method of forming a cholesteric liquid crystal layer described above, in a case where the composition layer is exposed to wind, the surface state of the formed cholesteric liquid crystal layer may be uneven. Considering this point, in the method of forming a cholesteric liquid crystal layer described above, it is preferable that the wind speed of the environment to which the composition layer is exposed is low in all steps of the step 2Y. Specifically, in the method of forming a cholesteric liquid crystal layer described above, the wind speed of the environment to which the composition layer is exposed is preferably 1 m/s or less in all steps of the step 2Y.

In a case where the composition layer is heated, the upper limit value of the increased temperature range of the heating treatment is not particularly limited, but is usually about 150° C.

<<Curing Treatment>>

In a case where the liquid crystal compound has a polymerizable group, it is preferable to carry out a curing treatment on the composition layer.

The procedure for carrying out the curing treatment on the composition layer is the same as in the method described in the step 2X, and a suitable aspect thereof is also the same.

As described above, in the step 1, the alignment treatment is carried out such that the alignment direction is different for each region in the plane of the alignment film for forming a surface of the liquid crystal layer. Thereby, in the liquid crystal layer that is formed using the disk-like liquid crystal compounds on the alignment film, the disk-like liquid crystal compounds are arranged for each region along the alignment direction. Therefore, the cholesteric liquid crystal layer is formed on the liquid crystal layer on which the disk-like liquid crystal compounds are arranged for each region in the different direction by the above described method, and the arrangement axis of the liquid crystal compound is formed along the arrangement direction of the disk-like liquid crystal compound for each region. As a result, a cholesteric liquid crystal layer having two or more regions where directions of the arrangement axes are different from each other as shown in FIG. 15 can be formed.

<<Other Aspects of Method of Forming Cholesteric Liquid Crystal Layer>>

As another formation method of forming the cholesteric liquid crystal layer 28 used for the laminated glass (windshield 14) according to the embodiment of the present invention, an alignment film in which a pattern is formed such that the liquid crystal compound in the cholesteric liquid crystal layer is arranged as the above described liquid crystal alignment pattern as a base layer during the formation of the cholesteric liquid crystal layer.

The alignment film is formed on the support, the composition is applied on the alignment film and cured, and thereby, a cholesteric liquid crystal layer, in which a predetermined liquid crystal alignment pattern is immobilized and which consists of a cured layer of the liquid crystal composition, can be obtained.

As the support, a transparent support is preferable, and a transparent substrate similar to the above described substrate can be used.

[Alignment Film]

As the alignment film, a so-called photo alignment film in which a photo-alignable material is irradiated with polarized light or non-polarized light to form an alignment film can also be used. That is, a photo alignment material may be applied onto the support to produce a photo alignment film. Irradiation with polarized light can be performed from the vertical direction or the oblique direction with respect to the photo alignment film, and irradiation with non-polarized light can be performed from the oblique direction with respect to the photo alignment film. In particular, in the case of irradiation from the oblique direction, a pretilt angle can be imparted to the liquid crystal.

Examples of the photo alignment material used for the photo alignment film capable of being used in the present invention include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B, aromatic ester compounds described in JP2002-229039A, maleimide and/or alkenyl-substituted nadiimide compounds having a photo-alignment unit described in JP2002-265541A and JP2002-317013A, photocrosslinkable silane derivatives described in JP4205195B and JP4205198B, photocrosslinkable polyimides, polyamides, or esters described in JP2003-520878A, JP2004-529220A, and JP4162850B, photodimerizable compounds described in JP1997-118717A (JP-H09-118717A), JP1998-506420A (JP-H10-506420A), JP2003-505561A, WO2010/150748A, JP2013-177561A, and JP2014-12823A, and particularly preferable examples thereof include synnamate compounds, chalcone compounds, and coumarin compounds. Azo compounds, photocrosslinkable polyimides, polyamides, esters, synnamate compounds, and chalcone compounds are particularly preferable.

After the alignment film is applied onto the support and dried, the alignment film is laser-exposed to form an alignment pattern. A schematic diagram of an alignment film exposure device is shown in FIG. 15.

An exposure device 71 includes a light source 74 provided with a laser 72 and a λ/2 plate 75, a polarization beam splitter 78 that separates a laser beam M from the laser 72 (light source 74) into two, and mirrors 80A and 80B disposed on optical paths of two separated light rays MA and MB, and λ/4 plates 82A and 82B, respectively. The λ/4 plates 82A and 82B have optical axes orthogonal to each other, the λ/4 plate 82A converts linearly polarized light P_{O} into a dextrorotatory circularly polarized light P_{R}, and the λ/4 plate 82B converts a linearly polarized light P_{O} into levorotatory circularly polarized light P_{L}.

The light source 74 includes the λ/2 plate 75, and emits linearly polarized light P_{O} by changing the polarization direction of the laser beam M emitted by the laser 72. The λ/4 plate 82A converts the linearly polarized light P_{O} (light ray MA) into the dextrorotatory circularly polarized light P_{R}, and λ/4 plate 82B converts the linearly polarized light P_{O} (light ray MB) into the levorotatory circularly polarized light P_{L}.

The support 86 provided with the alignment film 84 on which the alignment pattern is not yet formed is disposed at an exposed portion, the two light rays MA and MB intersect and interfere each other on the alignment film 84, and the alignment film 84 A is irradiated with and exposed to the interference light. Due to the interference in this case, the polarization state of light with which the alignment film 84 is irradiated periodically changes according to interference fringes. As a result, the alignment film (hereinafter, referred to as a patterned alignment film) 84 having an alignment pattern in which the alignment state periodically changes can be obtained. In the exposure device 71, a pitch of the alignment pattern (single period Λ) can be changed by changing an intersecting angle α of the two light rays MA and MB. By forming an optically-anisotoropic layer described later on the patterned alignment film having the alignment pattern in which the alignment state periodically changes, a cholesteric liquid crystal layer provided with a liquid crystal alignment pattern in accordance with this period can be formed.

In addition, by rotating the optical axes of the λ/4 plates 82A and 82B by 90°, respectively, a rotation direction of the optical axis of the liquid crystal compound in the liquid crystal alignment pattern can be reversed.

As described above, the patterned alignment film has a liquid crystal alignment pattern in which the liquid crystal compound is aligned such that the direction of the optical axis of the liquid crystal compound in the cholesteric liquid crystal layer formed on the patterned alignment film changes while continuously rotating in at least one in-plane direction. In a case where an axis in the direction in which the liquid crystal compound is aligned is an alignment axis, it can be said that the patterned alignment film has an alignment pattern in which the direction of the alignment axis changes while continuously rotating in at least one in-plane direction. The alignment axis of the patterned alignment film can be detected by measuring absorption anisotropy. For example, in a case where the amount of light transmitted through the patterned alignment film is measured by irradiating the patterned alignment film with linearly polarized light while rotating the patterned alignment film, it is observed that a direction in which the light amount is the maximum or the minimum gradually changes in the in-plane direction.

(Formation of Cholesteric Liquid Crystal Layer)

The cholesteric liquid crystal layer can be formed by applying multiple layers of the liquid crystal composition to the patterned alignment film. The application of the multiple layers refers to repetition of the following processes including: producing a first liquid crystal immobilized layer by applying the liquid crystal composition to the alignment film, heating the liquid crystal composition, cooling the liquid crystal composition, and irradiating the liquid crystal composition with ultraviolet light for curing; and producing a second or subsequent liquid crystal immobilized layer by applying the liquid crystal composition to the liquid crystal immobilized layer, heating the liquid crystal composition, cooling the liquid crystal composition, and irradiating the liquid crystal composition with ultraviolet light for curing as described above. Even in a case where the cholesteric liquid crystal layer is formed by the application of the multiple layers such that the total thickness of the cholesteric liquid crystal layer is large, the alignment direction of the alignment film can be reflected from a lower surface of the cholesteric liquid crystal layer to an upper surface thereof.

As the liquid crystal compounds included in the liquid crystal composition in this formation method, the above described rod-like liquid crystal compounds and disk-like liquid crystal compounds can be used.

The chiral agent included in the liquid crystal composition in this formation method is not limited, and a known compound (for example, Liquid Crystal Device Handbook (No. 142 Committee of Japan Society for the Promotion of Science, 1989), Chapter 3, Article 4-3, chiral agent for twisted nematic (TN) or super twisted nematic (STN), p. 199), isosorbide, an isomannide derivative, and the like can be used.

In the method of forming the cholesteric liquid crystal layer using this patterned alignment film, the liquid crystal composition may include a polymerization initiator, a crosslinking agent, an alignment control agent, and the like, and furthermore, as necessary, polymerization inhibitors, antioxidants, ultraviolet absorbers, light stabilizers, coloring materials, metal oxide fine particles, and the like can be added within a range in which the optical performance and the like does not deteriorate.

[Function and Effect of Laminated glass and HUD According to Embodiment of Invention]

The cholesteric liquid crystal layer 28 used for the laminated glass according to the embodiment of the present invention has a liquid crystal alignment pattern in which a direction of a molecular axis of the liquid crystal compound changes while continuously rotating along at least one in-plane direction. Bright and dark lines (a bright portion and a dark portion) that are derived from a cholesteric liquid crystalline phase and observed in a cross-section perpendicular to main surfaces of the cholesteric liquid crystal layer 28 by the SEM are tilted with respect to the main surfaces of the cholesteric liquid crystal layer 28.

As described above, the cholesteric liquid crystal layer 28 having the bright and dark lines tilted with respect to the main surfaces has reflection anisotropy in which the incident light is reflected at an angle different from an incident angle with respect to the main surfaces.

By using the laminated glass according to the embodiment of the present invention, which uses the cholesteric liquid crystal layer 28 having such reflection anisotropy as the windshield 14, the HUD 10 according to the embodiment of the present invention eliminates the double image and allows the projector 12 to be disposed on the ceiling 30 in the vehicle to realize a distant projection of a virtual image.

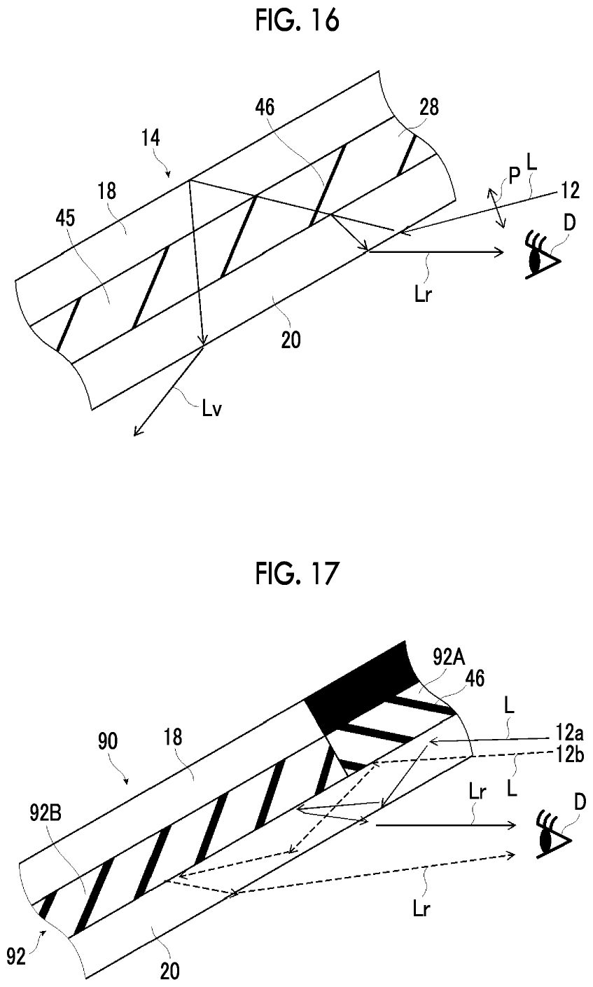

Hereinafter, description will be made with reference to a conceptual diagram of FIG. 16. In FIG. 16, for simplification of the drawing, the windshield 14 is provided with only the outer surface glass 18, the inner surface glass 20, and the cholesteric liquid crystal layer 28.

The projector 12 projects a projection light L at a selective reflection wavelength by the cholesteric liquid crystal layer 28 onto the windshield 14. As a preferable embodiment, the projector 12 causes the projection light L of P-polarized light to be incident on the windshield 14 as shown by arrow P.

The projection light L of P-polarized light is refracted by the inner surface glass 20. The projection light L is then converted into circularly polarized light in the revolving direction, which is selectively reflected by the cholesteric liquid crystal layer 28, by the λ/4 plate 26 (not shown), and is incident on the cholesteric liquid crystal layer 28.

The projection light incident on the cholesteric liquid crystal layer 28 is reflected by the cholesteric liquid crystal layer 28. Therefore, the cholesteric liquid crystal layer 28 has reflection anisotropy and reflects the incident light at an angle different from an incident angle with respect to the main surfaces.

Here, in the windshield 14, the tilt directions of the bright and dark lines (bright portion 45 and dark portion 46) of the cholesteric liquid crystal layer 28 parallel to the reflecting surface are set to an upward reflection direction. That is, a tilted surface of the bright and dark lines of the cholesteric liquid crystal layer 28 on the vehicle inner glass 20 side is directed toward the ceiling 30 side of the vehicle.

As a result, as shown in FIG. 16, a main image Lr formed by the cholesteric liquid crystal layer 28 can be reflected upward in the vehicle with respect to the incident direction of the projection light L. Therefore, in the HUD 10, the main image Lr is reflected toward a driver D so that the driver D can visually recognize the image.

On the other hand, the projection light L transmitted through the cholesteric liquid crystal layer 28 is reflected at the interface of the outer surface glass 18 with air. The reflection of light by the outer surface glass 18 has no reflection anisotropy and is specular reflection. Therefore, a sub image Lv obtained such that the projection light L incident from the ceiling side is reflected by the outer surface glass 18 is reflected toward the lower dashboard and is not visually recognized by the driver D.

That is, upon the HUD 10 according to the embodiment of the present invention using the laminated glass according to the embodiment of the present invention, the main image Lr and the sub image Lv reflected by the windshield 14 are projected through optical paths completely different from each other, and only the main image Lr can be visually recognized by the driver D. As a result, upon the HUD 10 according to the embodiment of the present invention, the double image can be eliminated.

The cholesteric liquid crystal layer 28 reflects only circularly polarized light in one revolving direction in the selective reflection wavelength region.

Therefore, the driver D can visually recognize ahead of the vehicle through the cholesteric liquid crystal layer 28, and the cholesteric liquid crystal layer 28 does not interfere with the driving.

In the laminated glass according to the embodiment of the present invention, since the cholesteric liquid crystal layer 28 has reflection anisotropy, the reflection direction of the main image Lr reflected by the windshield 14 using the laminated glass according to the embodiment of the present invention can be directed upward in the vehicle. Therefore, in the HUD 10 according to the embodiment of the present invention in which the laminated glass according to the embodiment of the present invention is used for the windshield 14, the projector 12 can be disposed on the ceiling.

The ceiling in the vehicle has a larger space than the inside of a dashboard of a HUD in the related art, in which the projector is disposed. Therefore, by disposing the projector 12 on the ceiling, the size, shape, and arrangement position of the projector 12 and the degree of freedom of the optical path from a real image of the projector 12 to the windshield 14 can be greatly increased. In addition, it is not necessary to allow the projection light from the projector 12 to pass through the window portion provided on the dashboard.

Therefore, upon the HUD 10 according to the embodiment of the present invention, it is possible to project a virtual image from a distance by sufficiently lengthening the optical path from the real image of the projector 12 to the windshield 14. Furthermore, the screen size of the HUD 10 can be increased by increasing the length of the optical path, increasing the size of the projector 12, and preventing the window portion from passing through.

FIG. 17 conceptually shows another example of a windshield using the laminated glass and the HUD according to the embodiment of the present invention.

Although not shown in FIG. 16, the windshield 90 shown in FIG. 17 also has a λ/4 layer 26 and an intermediate film 24.

The windshield 90 shown in FIG. 17 has a cholesteric liquid crystal layer 92.

The cholesteric liquid crystal layer 92 includes two regions of a region 92A and a region 92B where tilt directions of the bright and dark lines derived from the cholesteric liquid crystalline phase are opposite to each other.

In the region 92B, similarly to the cholesteric liquid crystal layer 28 described above, the tilt direction of the bright and dark lines (bright portion 45 and dark portion 46) is a direction in which the reflection direction with respect to the incident direction of the projection light is directed upward in the vehicle. On the other hand, the region 92A is provided in a light shielding unit or the like above the windshield, and the tilt direction of the bright and dark lines is a direction in which the reflection direction opposite to that of the region 92B is directed downward. That is, in the region 92B, the tilted surface of the bright and dark lines of the cholesteric liquid crystal layer 28 on the vehicle inner glass 20 side is set so as to face toward the ceiling 30 side of the vehicle, while in the region 92A, the tilted surface of the bright and dark lines of the cholesteric liquid crystal layer 28 on the vehicle inner glass 20 side is set so as to face toward the dashboard side of the vehicle.

In addition, in the region 92B, as a preferable embodiment, the incidence angle of the bright and dark lines gradually decreases from the upper side to the lower side. On the other hand, the incidence angle of the bright and dark lines in the region 92A is an angle at which the light reflected on the region 92B is totally reflected without exceeding a critical angle in a case where the light enters the interface between the inner surface glass 20 and the air.

The cholesteric liquid crystal layer 92 having the regions 92A and 92B in which the incidence angles of the bright and dark lines are opposite to each other can be formed by, for example, exposing the alignment film by the exposure device 71 shown in FIG. 15.

First, a region corresponding to the region 92A of the alignment film 84 is masked, and a region corresponding to the region 92B of the alignment film 84 is exposed by the exposure device 71. Next, the alignment film 84 is rotated by 180° with the normal line as the rotation axis, the region corresponding to the region 92B of the alignment film 84 is masked, and the region corresponding to the region 92A of the alignment film 84 is exposed by the exposure device 71.

By forming the cholesteric liquid crystal layer 92 on the alignment film 84 thus formed, it is possible to form the cholesteric liquid crystal layer 92 having the regions 92A and 92B in which the incidence angles of the bright and dark lines are opposite to each other.

As an example, a cholesteric liquid crystal layer in which the incidence angle of the bright and dark lines gradually decreases from the upper side to the lower side as in the region 92B can be formed by exposing the alignment film by the exposure device 71 shown in FIG. 15.

First, the alignment film 84 is exposed by the exposure device 71 by masking the region 92B other than a region where the incidence angle of the bright and dark lines is the largest. Next, the region other than a region where the incidence angle of the bright and dark lines is the second largest is masked, and the intersecting angle α of the two light rays MA and MB is adjusted so that the period of the alignment pattern (single period Λ) becomes long, and the alignment film 84 is exposed by the exposure device 71. Next, the region other than a region where the incidence angle of the bright and dark lines is the third largest is masked, and the intersecting angle α of the two light rays MA and MB is adjusted so that the period of the alignment pattern becomes long, and the alignment film 84 is exposed by the exposure device 71. Next, the region other than a region where the incidence angle of the bright and dark lines is the fourth largest is masked, and the intersecting angle α of the two light rays MA and MB is adjusted so that the period of the alignment pattern becomes long, and the alignment film 84 is exposed by the exposure device 71.

Hereinafter, by repeating the same exposure of the alignment film 84, the period of the alignment pattern in the alignment film 84 is gradually lengthened from the upper side to the lower side of the windshield 90 to form the alignment film 84.

By the formation of the cholesteric liquid crystal layer 92 on the alignment film 84, it is possible to form the region 92B where the incidence angle of the bright and dark lines gradually decreases from the upper side to the lower side.

In the HUD using such the windshield 90, for example, two projectors 12a and 12b arranged in the vehicle width direction emit projection light to the region 92A.

In the HUD in which the cholesteric liquid crystal layer 92 uses the windshield 90 including the region 92A that reflects the projection light L downward corresponding to the light shielding unit, the projectors 12a and 12b can be disposed in the immediate vicinity of the windshield 90.

Projection light (solid line) emitted from the projector 12a and projection light (broken line) emitted from the projector 12b are first reflected on the region 92A of the cholesteric liquid crystal layer 92, and then totally reflected at the interface between the inner surface glass 20 and the air.

The projection light reflected by the inner surface glass 20 propagates in the inner surface glass 20 downward, repeats reflection on the region 92B of the cholesteric liquid crystal layer 92 and reflection on the inner surface glass 20, and is emitted from the windshield 90 in a case of exceeding the critical angle due to the reflection on the region 92B, thereby the projection light being visually recognized by the driver D as the main image Lr.

That is, in the HUD using the windshield 90 including the cholesteric liquid crystal layer 92 having the regions 92A and 92B in which the tilt directions of the bright and dark lines are opposite to each other, the inner surface glass 20 is used as a light guide plate to widen a display position in the vertical direction, and as a result, the screen size can be made larger. In this example, the display position in the vertical direction can be changed depending on an emission angle of the projection light L from the projectors 12a and 12b.

In the example shown in FIG. 17, as a preferable embodiment, in the region 92B of the cholesteric liquid crystal layer 92, the incidence angle of the bright and dark lines gradually decreases from the upper side to the lower side. However, even though the incidence angle of the bright and dark lines in the region 92B is constant, the screen size of the HUD can be increased by the same function and effect.

In addition, by using two projectors 12a and 12b arranged in the vehicle width direction, it is possible to increase the screen size in the vehicle width direction as well. This configuration can also be used in the HUD 10 shown in FIGS. 1, 16, and the like described above.

Even in the HUD using the windshield 90, it is possible to prevent the double image from being visually recognized by the driver D for the same reason as the windshield 14 described with reference to FIG. 16.

In the above example, the projectors 12a and 12b are disposed in the immediate vicinity of the windshield 90. However, the present invention is not limited thereto, and the projectors 12a and 12b may be disposed at any positions on the ceiling in the vehicle as in the example shown in FIG. 1.

Also in this case, the screen size of the HUD can be increased by adjusting the emission angle of the projection light from the projectors 12a and 12b and similarly using the inner surface glass 20 as the light guide plate. In this case, the region 92A that reflects the projection light L downward is unnecessary.

In addition, in the configuration in which the inner surface glass 20 is used as the light guide plate, even though the region 92A is provided downward and the projector is disposed on the dashboard side, it is possible to prevent the double image from being visually recognized by the driver D. As described above, the double image occurs from which the projection light from the projector is reflected by the outer surface glass of the windshield that is a laminated glass, and the image reflected by the outer surface glass is observed by a driver as a sub image deviated from the main image. However, in the configuration in which the inner surface glass 20 is used as the light guide plate, the reflected light from the outer surface glass 18 propagates inside (totally reflected on) the outer surface glass 18 and is emitted from the outer surface side. Therefore, the reflected light may not be visually recognized by the driver. Therefore, even though the projector is disposed on the dashboard side, it is possible to prevent the double image from being visually recognized by the driver D.

The image on the HUD basically does not need to be visually recognized at the passenger seat side.

Therefore, in order to increase the screen size in the vehicle width direction, the passenger seat side may also be irradiated with the projection light of the projector to be reflected by the cholesteric liquid crystal layer of the windshield to the driver seat side.

As an example, such a cholesteric liquid crystal layer may be produced as follows.

That is, in a case where the alignment film 84 is exposed by the exposure device 71 shown in FIG. 15 described above, an angle of a deflection axis of the linearly polarized light P₀ is adjusted in the plane so that the direction in which the alignment pattern changes periodically is changed in the plane of the alignment film 84, thereby the alignment film 84 being exposed. Specifically, as an example, in a case where the alignment film 84 is exposed by the exposure device 71, the alignment film 84 (support 86) is slightly rotated and the exposure position is slightly shifted for exposure, which are repeated.

As a result, it possible to change the tilt directions of the bright and dark lines of the cholesteric liquid crystal layer in the plane. Therefore, according to this exposure method of the alignment film 84, a cholesteric liquid crystal layer capable of reflecting light toward the driver from any position of the windshield can be formed.

Although the laminated glass and the HUD according to the embodiment of the present invention have been described in detail above, the present invention is not limited to the examples described above. It goes without saying that the present invention may perform improvement, modification, and the like in various ways within a scope that does not depart from the gist of the present invention.

### EXAMPLES

Hereinafter, the present invention will be described in more detail with reference to specific examples of the present invention. However, the present invention is not limited to the following examples.

### Example 1

<Production of Support>

<<Saponification of Support>>

A commercially available triacetyl cellulose film “Z-TAC” (manufactured by Fujifilm Corporation) was used as a support.

The support was allowed to pass through dielectric heating rolls at a temperature of 60° C. to increase the temperature of the support surface to 40° C. Thereafter, one side of the support was coated with an alkaline solution described below at a coating amount of 14 m1/m² by using a bar coater, and the support was heated at 110° C. and further transported under a steam-type far infrared heater (manufactured by Noritake Co., Ltd.) for 10 seconds.

Subsequently, pure water was applied onto the support surface in an amount of 3 m1/m². Next, washing with water using a fountain coater and dehydration using an air knife were repeated three times, and the film was then transported into a drying zone at 70° C. for 10 seconds, and dried therein to obtain an alkali saponification-treated support.

-Alkaline Solution-

| | |
|---|---|
| Potassium Hydroxide | 4.70 parts by mass |
| Water | 15.80 parts by mass |
| Isopropanol | 63.70 parts by mass |
| Surfactant (SF-1: C₁₄H₂₉O(CH₂CH₂O)₂OH) | 1.0 part by mass |
| Propylene glycol | 14.8 parts by mass |

<<Formation of Undercoat Layer>>

The following coating liquid for forming an undercoat layer was continuously applied on the alkali saponification-treated support with a #8 wire bar. The support on which the coating film was formed was dried with hot air at 60° C. for 60 seconds and further dried with hot air at 100° C. for 120 seconds, thereby forming an undercoat layer.

(Coating Liquid for Forming Undercoat Layer)

| | |
|---|---|
| Modified polyvinyl alcohol described below | 2.40 parts by mass |
| Isopropyl alcohol | 1.60 parts by mass |
| Methanol | 36.00 parts by mass |
| Water | 60.00 parts by mass |

### Modified Polyvinyl Alcohol

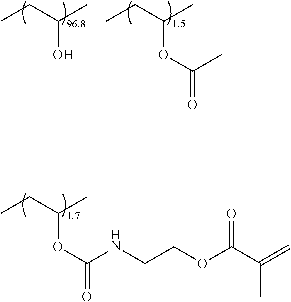

<<Formation of Alignment Film P-1>>

The following coating liquid for forming an alignment film P-1 was continuously applied to the support on which the undercoat layer was formed using a #2 wire bar. The support on which the coating film of the coating liquid for forming an alignment film P-1 was formed was dried with hot air at 60° C. for 60 seconds to form an alignment film P-1.

-Coating Liquid for Forming Alignment Film P-1-

| | |
|---|---|
| Photo alignment material described below | 1.00 part by mass |
| Water | 16.00 parts by mass |
| Butoxyethanol | 42.00 parts by mass |
| Propylene glycol monomethyl ether | 42.00 parts by mass |

Photo Alignment Material

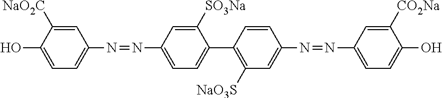

<<Exposure of Alignment Film P-1>>

The alignment film was exposed using the exposure device 71 shown in FIG. 15.

In the exposure device 71, a semiconductor laser that emits a laser beam having a wavelength (405 nm) was used as the laser 72. The exposure amount due to the interference light was set to 100 mJ/cm². In the formation of each reflective layer described later, the incidence angle of the bright and dark lines in the cholesteric liquid crystalline phase was controlled by changing the intersecting angle α of the two laser beams.

<Formation of Cholesteric Liquid Crystal Layer>

<<Formation of Reflective Layer B1>>

A component of a cholesteric liquid crystal composition B1 described below was stirred and dissolved in a vessel maintained at 25° C. to prepare a cholesteric liquid crystal composition B1.

The cholesteric liquid crystal composition B1 is a material for forming a layer that reflects dextrorotatory circularly polarized light.

-Cholesteric Liquid Crystal Composition B1-

| | |
|---|---|
| The following liquid crystal compound L-1 | 100.0 parts by mass |
| IRGACURE 819 (manufactured by BASF SE) | 10.0 parts by mass |
| Chiral agent A with the following structure | 5.08 parts by mass |
| Surfactant with the following structure | 0.08 parts by mass |
| Solvent (methyl ethyl ketone) | the amount of a solute |
| | concentration of 30% |
| | by mass |

Liquid Crystal Compound L-1

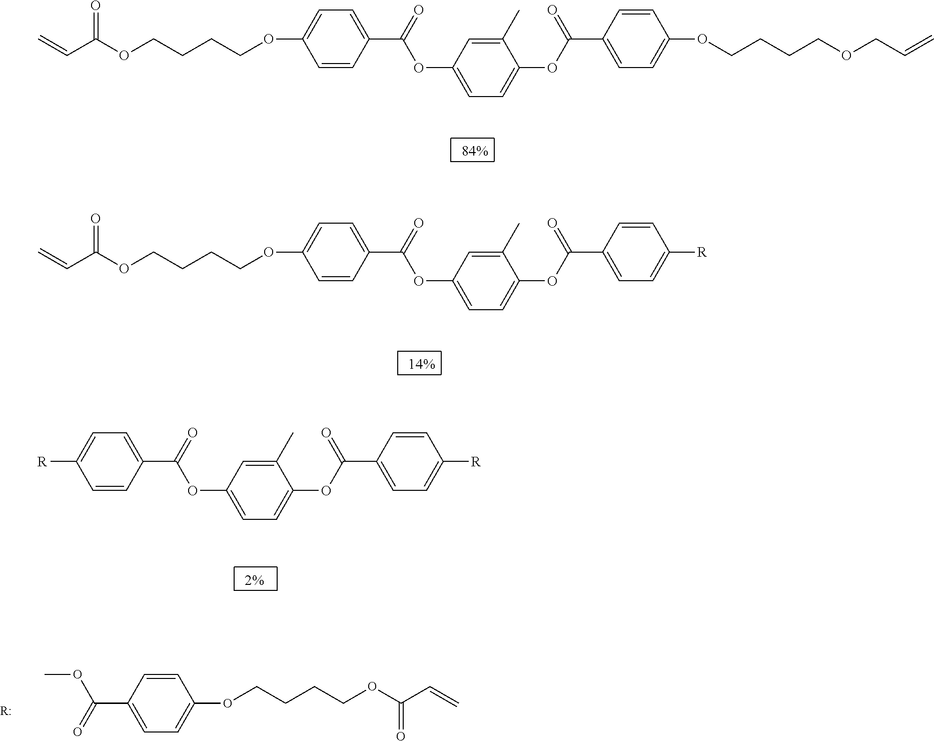

Chiral agent A

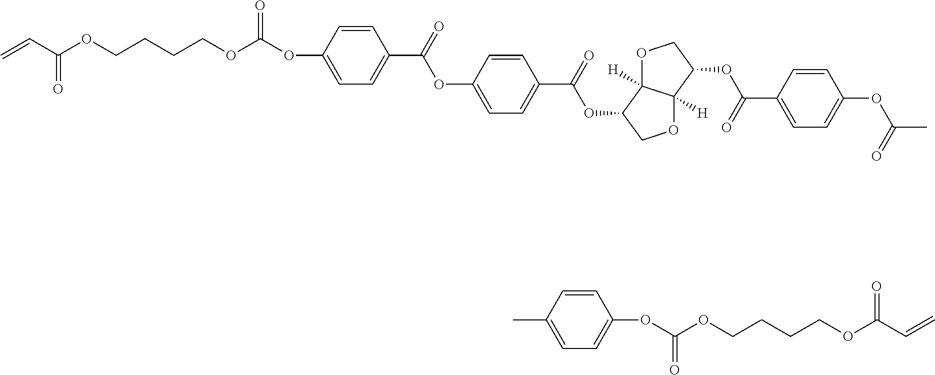

Surfactant

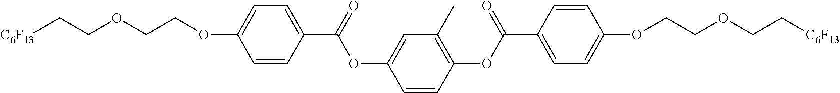

The cholesteric liquid crystal composition B1 was uniformly applied to the surface of the alignment film of the support having a base layer and the alignment film produced above, by using a slit coater. Then, after drying at 95° C. for 30 seconds, a reflective layer B1 consisting of a cholesteric liquid crystal layer having a thickness of 0.5 μm was produced by irradiation with an ultraviolet ray of 500 mJ/cm² at room temperature with an ultraviolet irradiation device to be cured.

<<Formation of Reflective Layer G1>>

A cholesteric liquid crystal composition G1 was prepared in the same manner as the cholesteric liquid crystal composition B1 except that the addition amount of the chiral agent A was 4.47 parts by mass. A reflective layer G1 was produced in the same manner as the reflective layer B1 except that the cholesteric liquid crystal composition G1 was used.

<<Formation of Reflective Layer R1>>

A cholesteric liquid crystal composition G1 was prepared in the same manner as the cholesteric liquid crystal composition B1 except that the addition amount of the chiral agent A was 3.69 parts by mass. A reflective layer R1 was produced in the same manner as the reflective layer B1 except that the cholesteric liquid crystal composition G1 was used.

The cross-sections of the reflective layer B1, G1, and R1 observed with the SEM, incidence angles of the bright and dark lines (bright portion and dark portion) in the cholesteric liquid crystalline phase and lengths of helical pitches in the cholesteric liquid crystalline phase were measured from the analysis of the SEM images. The incidence angle of the bright and dark lines is an angle formed between the main surface of the cholesteric liquid crystal layer and the bright and dark line, and in a case where the bright and dark lines are parallel to the main surface, the incidence angle is 0°.

The results are shown in Table 1.

TABLE 1
<Production of Retardation Film Q1>

| | Reflective | Reflective | Reflective |
|---|---|---|---|
| | layer B1 | layer G1 | layer R1 |
| Incidence angle [°] | 35 | 35 | 35 |
| Helical pitch [nm] | 360 | 410 | 510 |

Next, a component of a liquid crystal composition Q1 described below was stirred and dissolved in a vessel maintained at 25° C. to prepare a liquid crystal composition Q1.

-Liquid Crystal Composition Q1-

| | |
|---|---|
| The above liquid crystal compound L-1 | 100.0 parts by mass |
| IRGACURE 819 (manufactured by BASF SE) | 10.0 parts by mass |
| Surfactant with the above structure | 0.08 parts by mass |
| Solvent (methyl ethyl ketone) | the amount of a solute |
| | concentration of 30% |
| | by mass |

Next, in the same manner as before, a support on which the undercoat layer was formed was produced. Next, the undercoat layer of the support was subjected to a rubbing treatment.

The liquid crystal composition Q1 was continuously applied on the rubbing-treated undercoat layer with a #2.8 wire bar, and then aged at 90° C. for one minute. Subsequently, a retardation film Q1 was produced by irradiation with ultraviolet rays at an irradiation amount of 500 mJ/cm² at 30° C. and a nitrogen atmosphere to carry out a polymerization reaction of the liquid crystal compound.

As a result of measuring the optical characteristics with Axoscan (manufactured by Axometrics, Inc.), the measurement result was Re (550)/Rth (550)=140/70. A slow axis direction was the same as the rubbing-treated direction. Re is an in-plane retardation, and Rth is retardation in a thickness direction.

<Production of Laminated Glass 1>

As the vehicle outer glass, a glass plate (manufactured by Central Glass Co., Ltd., FL2, visible light transmittance of 90%) having a length of 300 mm×a width of 300 mm×a thickness of 2 mm was prepared.

An intermediate film (a PVB film manufactured by Sekisui Chemical Co., Ltd.) that was cut to the same size as the vehicle outer glass and had a thickness of 0.76 mm was laminated on the vehicle outer glass.

The reflective layer R1, the reflective layer G1, the reflective layer B1, and the retardation film Q1 were laminated thereon in this order. At this time, the reflective layers were laminated such that the tilted surface of the bright and dark lines of the cholesteric liquid crystalline phase on the retardation film Q1 side faces toward the upper side of the vehicle outer glass. In addition, as conceptually shown in FIG. 19, the retardation film Q1 was installed such that a slow axis Sa was 135° with respect to the upper side of the glass indicated by the broken line.

Furthermore, as a vehicle inner glass, the same glass plate as the vehicle outer glass was laminated.

This laminate was held at 90° C. and 10 kPa (0.1 atm) for 1 hour, and then heated in an autoclave (manufactured by Kurihara Seisakusho, K.K.) at 115° C. and 1.3 MPa (13 atm) for 20 minutes to remove air bubbles, and thus a laminated glass was obtained.

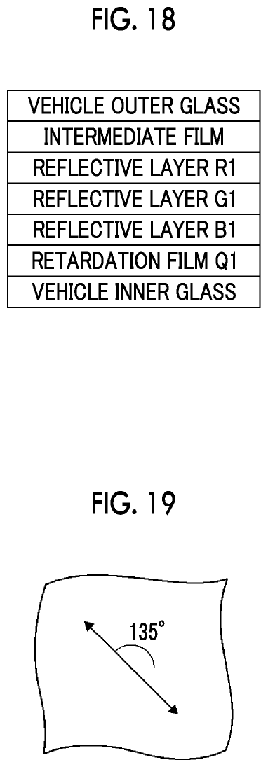

As a result, as shown in FIG. 18, a laminated glass 1 was produced by laminating the vehicle inner glass, the retardation film Q1, the reflective layer B1, the reflective layer G1, the reflective layer R1, and the vehicle outer glass in this order.

<Evaluation Standard of Double Image>

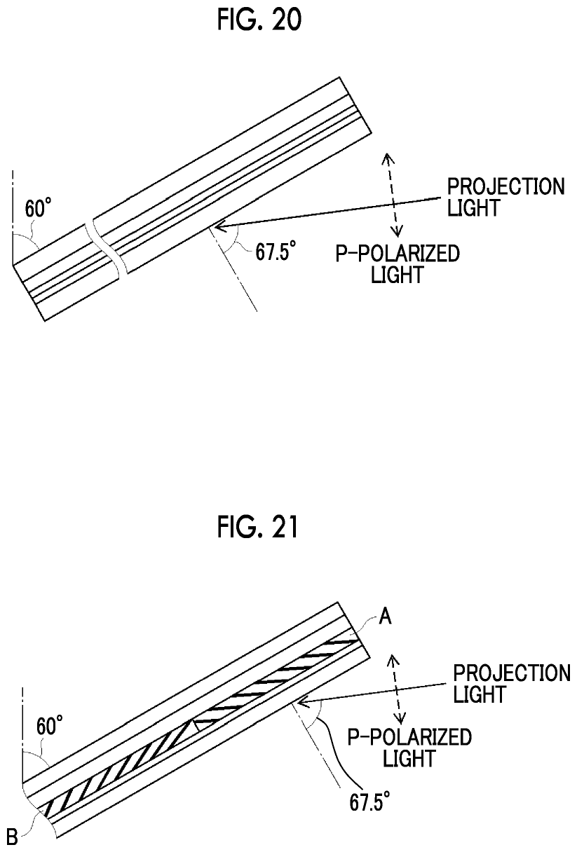

As conceptually shown in FIG. 20, the produced laminated glass 1 was immobilized such that a polar angle was 60°. The polar angle is an angle formed in the vertical direction.

A commercially available HUD (ND-HUD3 manufactured by Pioneer Corporation) was disassembled, and the projector unit was taken out.

As shown in FIG. 20, projection light was projected from the projector onto the vehicle inner glass by an angle of 67.5° with respect to the normal line (dashed line) of the laminated glass 1. At this time, the direction of the projector was adjusted so that the projection light was P-polarized light.

In a case of observation within a range where the reflected image of the projector inside the vehicle can be seen, it was confirmed that the double image could not be seen from any position.

### Example 2

A part of the alignment film P-1 produced in Example 1 was covered with black paper, and the alignment film 84 was partially exposed by using the exposure device 71 shown in FIG. 15. Next, the support 86 was rotated by 180° with the normal line as the rotation axis, and the remaining unexposed portion of the alignment film 84 was exposed using the exposure device 71. As a result, a region A and a region B were formed on the alignment film 84. In this case, in the formation of each reflective layer, an angle of the intersecting angle α in the exposure device 71 was controlled so that the bright and dark lines of the cholesteric liquid crystalline phase had an incidence angle described later.

Three support sheets including an alignment film in which such an alignment pattern was formed were prepared. The cholesteric liquid crystal compositions B1, G1, and R1 were applied to the alignment film of each support in the same manner as in Example 1 to prepare reflective layers B2, G2, and R2.

In the same manner as in Example 1, incidence angles of the bright and dark lines (bright portion and dark portion) in the cholesteric liquid crystalline phase and lengths of helical pitches in the cholesteric liquid crystalline phase were measured by the analysis of the SEM images. In addition, it was confirmed that the tilt directions of the bright and dark lines differed by 180° between the region A and the region B.

The results are shown in Table 2.

TABLE 2

| | Reflective | Reflective | Reflective |
|---|---|---|---|
| | layer B2 | layer G2 | layer R2 |
| Region | A/B | A/B | A/B |
| Incidence angle [°] | 40/3 | 40/3 | 40/3 |
| Helical pitch [nm] | 380/290 | 435/330 | 535/410 |

<Production of Laminated Glass 2>

A laminated glass 2 was produced in the same manner as in Example 1 except that the reflective layer B1 was used instead of the reflective layer B2, the reflective layer G1 was used instead of the reflective layer G2, and the reflective layer R1 was used instead of the reflective layer R2.

<Evaluation Standard of Double Image>

As conceptually shown in FIG. 21, the laminated glass 2 and the projector were disposed in the same manner as in Example 1, and the projection light (P-polarized light) was projected from the projector onto the laminated glass 2. The projector was disposed so that the projection light was incident on the region A.

In a case of observation within a range where the reflected image of the projector inside the vehicle can be seen, it was confirmed that the double image could not be seen from any position.

### Comparative Example 1

A support including an undercoat layer and an alignment film was produced in the same manner as in Example 1.

The alignment film of the support was subjected to an alignment treatment by rubbing.

Three support sheets each of which had the alignment film subjected to the alignment treatment by rubbing were prepared. The cholesteric liquid crystal compositions B1, G1, and R1 were applied to the alignment film of each support in the same manner as in Example 1 to produce reflective layers B3, G3, and R3.

In the same manner as in Example 1, incidence angles of the bright and dark lines (bright portion and dark portion) in the cholesteric liquid crystalline phase and lengths of helical pitches in the cholesteric liquid crystalline phase were measured by the analysis of the SEM images.

The results are shown in Table 3.

TABLE 3

| | Reflective | Reflective | Reflective |
|---|---|---|---|
| | layer B3 | layer G3 | layer R3 |
| Incidence angle [°] | 0 | 0 | 0 |
| Helical pitch [nm] | 360 | 410 | 510 |

That is, in this example, the bright and dark lines in the cholesteric liquid cholesteric liquid crystalline phase are parallel to the main surface of the cholesteric liquid crystal layer.

<Production of Laminated Glass 3>

A laminated glass 3 was produced in the same manner as in Example 1 except that the reflective layer B1 was used instead of the reflective layer B3, the reflective layer G1 was used instead of the reflective layer G3, and the reflective layer R1 was used instead of the reflective layer R3.

<Evaluation Standard of Double Image>

The laminated glass 3 and the projector were disposed in the same manner as in Example 1, as shown in FIG. 20, and the projection light (P-polarized light) was projected from the projector onto the laminated glass 3. The projection light was projected from below at an angle of 67.5° with respect to the normal line of the laminated glass 3 so as to be symmetrical with that of Example 1.

In a case of observation within a range where the reflected image of the projector inside the vehicle can be seen, the double images were visually recognized from various positions.

From the above results, the effect of the present invention is clear.

The present invention can be suitably used as information display means on a windshield in vehicles, aircrafts, ships, and the like.

### EXPLANATION OF REFERENCES

10: head-up display (HUD)
12, 12a, 12b: projector
14: windshield
18: outer surface glass
20: inner surface glass
24: intermediate film
26: λ/4 plate
28, 50, 100: cholesteric liquid crystal layer
30: ceiling
41, 42, 43, 51, 52, 53, 101, 102, 103: main surface
44, 54, 104: liquid crystal compound
45, 105: bright portion
46, 106: dark portion
68: disk-like liquid crystal compound
71: exposure device
72: laser
74: light source
75: λ/2 plate
78: polarization beam splitter
80A, 80B: mirror
82A, 82B: λ/4 plate
84: support
86: alignment film
L₁, L₂, L₃, L₄, L₅: molecular axis
D₁, D₂: arrangement axis
θ₂, θ₅, θ₁₀, θₐ₁, θₐ₂, θₐ₃, θ_{b1}, θ_{b2}, θ_{b3}: angle
C₁, C₂, C₃: helical axis derived from cholesteric liquid crystalline phase
T₁, T₂, T₃: reflecting surface
P₁, P₂: arrangement direction of bright portion and dark portion arranged alternately
M: laser beam
MA, MB: light ray
P_{O}: linearly polarized light
P_{R}: dextrorotatory circularly polarized light
P_{L}: levorotatory circularly polarized light
α: intersecting angle
D: driver

What is claimed is:

1. A laminated glass comprising:
two glass plates;
an intermediate film provided between the two glass plates; and
a cholesteric liquid crystal layer formed by using a liquid crystal compound,
wherein the cholesteric liquid crystal layer has a liquid crystal alignment pattern in which a direction of a molecular axis of the liquid crystal compound changes while continuously rotating along at least one in-plane direction on at least one main surface of a pair of main surfaces, and
a bright portion and a dark portion derived from a cholesteric liquid crystalline phase in a cross-section perpendicular to the main surfaces of the cholesteric liquid crystal layer, which are observed by a scanning electron microscope, are tilted with respect to the main surfaces of the cholesteric liquid crystal layer.

2. The laminated glass according to claim 1, further comprising a λ/4 plate.

3. The laminated glass according to claim 1,
wherein the cholesteric liquid crystal layer includes a region where incidence angles of the bright portion and dark portion derived from the cholesteric liquid crystalline phase are different from each other.

4. The laminated glass according to claim 1,
wherein the cholesteric liquid crystal layer includes a region where tilt directions of the bright portion and dark portion derived from the cholesteric liquid crystalline phase are opposite to each other.

5. The laminated glass according to claim 1,
wherein the cholesteric liquid crystal layer is disposed between the two glass plates.

6. The laminated glass according to claim 1,
wherein the cholesteric liquid crystal layer is disposed on one of the two glass plates on a side opposite to the intermediate film.

7. A head-up display comprising:
the laminated glass according to claim 1; and
a projector that emits projection light to the laminated glass,
wherein the projector is disposed on a ceiling of an image observation space.

8. The head-up display according to claim 7,
wherein the projector emits P-polarized light to the laminated glass.

9. The head-up display according to claim 7,
wherein the head-up display is mounted on a vehicle, and
the projector is disposed on a ceiling in the vehicle.

10. The laminated glass according to claim 3,
wherein the cholesteric liquid crystal layer includes a region where tilt directions of the bright portion and dark portion derived from the cholesteric liquid crystalline phase are opposite to each other.

11. The laminated glass according to claim 3,
wherein the cholesteric liquid crystal layer is disposed on one of the two glass plates on a side opposite to the intermediate film.

12. A head-up display comprising:
the laminated glass according to claim 3; and
a projector that emits projection light to the laminated glass,
wherein the projector is disposed on a ceiling of an image observation space.

13. The head-up display according to claim 12,
wherein the projector emits P-polarized light to the laminated glass.

14. The head-up display according to claim 12,
wherein the head-up display is mounted on a vehicle, and
the projector is disposed on a ceiling in the vehicle.

15. The laminated glass according to claim 4,
wherein the cholesteric liquid crystal layer is disposed on one of the two glass plates on a side opposite to the intermediate film.

16. A head-up display comprising:
the laminated glass according to claim 4; and
a projector that emits projection light to the laminated glass,
wherein the projector is disposed on a ceiling of an image observation space.

17. The head-up display according to claim 16,
wherein the projector emits P-polarized light to the laminated glass.

18. The head-up display according to claim 16,
wherein the head-up display is mounted on a vehicle, and
the projector is disposed on a ceiling in the vehicle.

19. The laminated glass according to claim 2,
wherein the cholesteric liquid crystal layer includes a region where incidence angles of the bright portion and dark portion derived from the cholesteric liquid crystalline phase are different from each other.

20. The laminated glass according to claim 2,
wherein the cholesteric liquid crystal layer includes a region where tilt directions of the bright portion and dark portion derived from the cholesteric liquid crystalline phase are opposite to each other.
